(19) United States
(12) Patent Application Publication
(10) Pub. No.: US 2024/0167576 A1
(43) Pub. Date: May 23, 2024

(54) ELASTIC GUIDED VALVE

(71) Applicant: Halliburton Energy Services, Inc., Houston, TX (US)

(72) Inventors: Justin Lee HURST, Duncan, OK (US); James Alan OLIS, Duncan, OK (US); Timothy Holiman HUNTER, Duncan, OK (US); Frank KRESSE, III, Duncan, OK (US)

(21) Appl. No.: 17/989,166

(22) Filed: Nov. 17, 2022

(51) Int. Cl. F16K 15/06; E21B 41/00; F04B 47/00; F04B 53/10

(52) U.S. Cl. CPC F16K 15/064; E21B 41/00; F04B 47/00; F04B 53/10

(57) ABSTRACT

A valve assembly comprising a valve body, a valve housing, and a spring member coupling the valve body to the valve housing. The spring member is configured to align the contact surface of the valve body with the valve seat inside the valve housing. The spring member can be located on the discharge side of the valve body. The valve assembly may be disposed in a fluid end of a positive displacement pump that is operated to flow a wellbore servicing fluid into a wellbore.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present disclosure relates generally to valves, for example valves contained in pumps that are used to pump a wellbore servicing fluid. More particularly, the present disclosure relates to valves used in reciprocating devices for pumping fluids into a wellbore and methods of using same.

### BACKGROUND

High-pressure pumps having reciprocating elements such as plungers or pistons are commonly employed in oil and gas production fields for operations such as drilling and well servicing. For instance, one or more reciprocating pumps may be employed to pump fluids into a wellbore in conjunction with activities including fracturing, acidizing, remediation, cementing, and other stimulation or servicing activities. Due to the harsh conditions associated with such activities, many considerations are generally taken into account when designing a pump for use in oil and gas operations. One design consideration may concern life and reliability of pump fluid end components, as reciprocating pumps used in wellbore operations, for example, often encounter high cyclical pressures and various other conditions that can render pump components susceptible to wear and result in a need for servicing and maintenance of the pump.

Accordingly, it is desirable to provide a valve assembly that enhances life and reliability of a reciprocating pump comprising same.

### BRIEF SUMMARY OF THE DRAWINGS

For a more complete understanding of this disclosure, reference is now made to the following brief description, taken in connection with the accompanying drawings and detailed description, wherein like reference numerals represent like parts.

FIG. 1 is an elevational view of a reciprocating pump.

FIG. 2A is a cut-away illustration of an exemplary reciprocating pump comprising a concentric bore pump fluid end.

FIG. 2B is a cut-away illustration of an exemplary reciprocating pump comprising a cross-bore (e.g., a tee-bore (“T-bore”)) pump fluid end.

FIG. 3 is cut-away illustration of a pump power end of a pump.

FIG. 4A is a schematic of a valve assembly in the closed position according to an embodiment of the disclosure.

FIG. 4B is a schematic of a valve assembly in the open position according to an embodiment of the disclosure.

FIG. 5 is a schematic of a valve assembly in the open position according to another embodiment of the disclosure.

FIG. 6 is an isometric view of a valve assembly in the closed position according to an embodiment of the disclosure.

FIG. 7A is a top view of a valve body assembly according to still another embodiment of the disclosure.

FIG. 7B is a partial cross-sectional view of a valve body assembly according to still another embodiment of the disclosure.

FIG. 8 is an isometric view of valve assembly according to yet another embodiment of the disclosure.

FIG. 9 is a partial cross-sectional view of a progressive spring assembly according to an embodiment of the disclosure.

FIG. 10A is a partial cross-sectional view of a valve assembly according to another embodiment of the disclosure.

FIG. 10B is an end view of a valve assembly according to another embodiment of the disclosure.

FIG. 11 is a partial cross-sectional view of a valve assembly according to another embodiment of the disclosure.

FIG. 12A is a partial cross-sectional view of a valve assembly according to still another embodiment of the disclosure.

FIGS. 12B and 12C are end views of a valve assembly according to still another embodiment of the disclosure.

FIG. 13 is a schematic representation of a wellbore servicing system according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

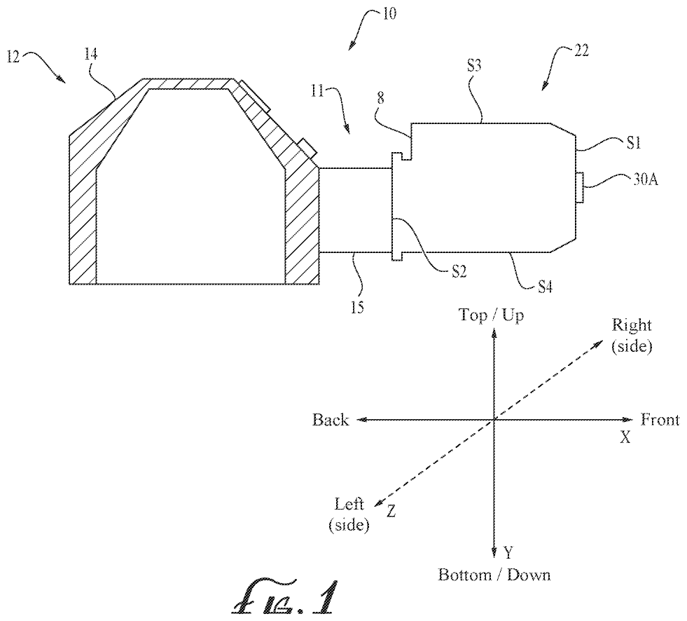

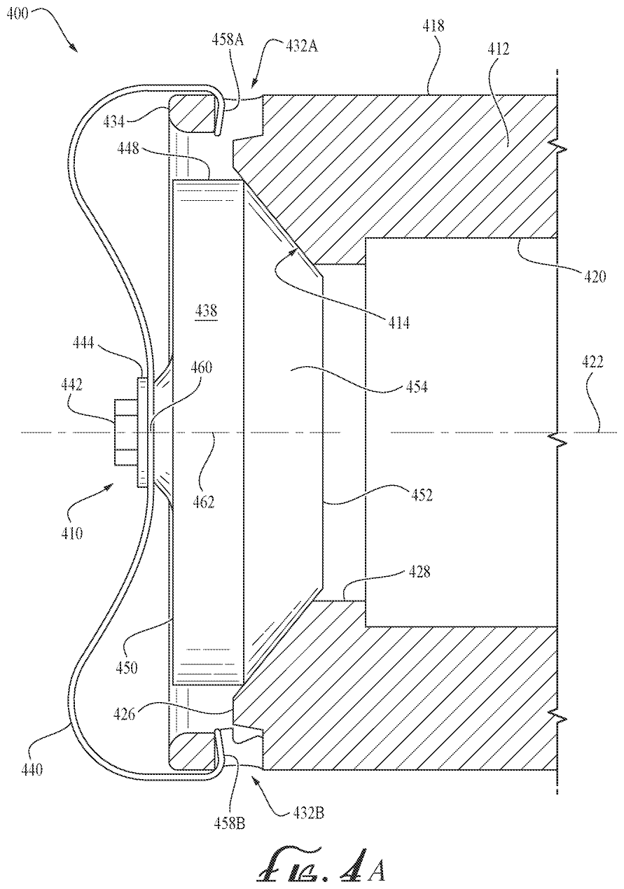

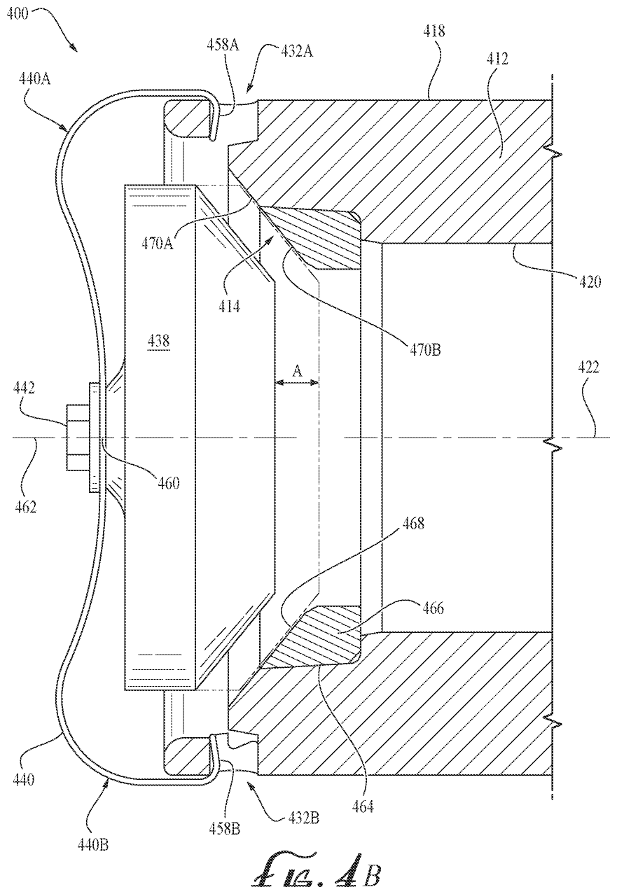

Disclosed herein is a reciprocating apparatus for pumping pressurized fluid. In embodiments, the reciprocating apparatus comprises an aligned valve assembly comprising a valve body and a valve alignment device connecting the valve body to the reciprocating apparatus, wherein the center axis of the valve body is aligned with the center axis of the reciprocating apparatus. An aligned valve assembly of the type disclosed herein can be used in conjunction with a pump, and more specifically a fluid end of a high pressure pump, that is configured in any suitable orientation with respect to the earth's surface, e.g., in vertical relative to the earth's surface, horizontal relative to the earth's surface, or angled/deviated relative to the earth′ surface for example as shown with reference to the X-Y-Z coordinates shown in FIG. 1. In a particular embodiment, an aligned valve assembly of the type disclosed herein can be configured about horizontal in comparison to the earth's surface, and such may be referred to as a horizontal aligned valve, a horizontally oriented valve, a horizontal valve, or the like, for example as shown and described with reference to FIGS. 4-11 herein. Likewise, it should be understood to a person of ordinary skill that in describing the details of the valve assembly in a horizontal position, that the term “horizontal” may be omitted in configurations employing a similar or like valve assembly structure but positioned in a pump (e.g., pump fluid end) in an orientation other than horizontal.

In plunger or piston pumps using horizontally oriented valves, such as in concentric pumps, certain designs can require the use of valves having an alignment device on the side opposite of the sealing surface, and such valves can be referred to as horizontal aligned valves or horizontal aligned valve assemblies. The design of the presently disclosed horizontal aligned valve moves or urges the valve body towards the valve seat while aligning the seal surface of the valve body with the seal surface of the valve seat without adding any additional weight of an additional guiding or vane feature. The urging and guiding feature will allow the horizontal aligned valve to seal in a centered position. By locating the urging and guiding feature on the side opposite of the sealing surface, the mass of the valve body is reduced which also reduces the momentum and reaction time of the valve body. The urging and aligning feature can also be distributed about the valve body so that during operation, e.g., opening and closing, the center axis of the horizontal aligned valve will remain parallel to the flow path which allows for alignment with the seal surface.

Disclosed herein is a reciprocating apparatus for pumping pressurized fluid. In embodiments, the reciprocating apparatus comprises a horizontal aligned valve assembly comprising a valve body and a valve alignment device connecting the valve body to the reciprocating apparatus, wherein the center axis of the valve body is aligned with the center axis of the reciprocating apparatus.

A reciprocating apparatus of this disclosure may comprise any suitable pump operable to pump fluid. Non-limiting examples of suitable pumps include, but are not limited to, piston pumps, plunger pumps, and the like. In embodiments, the pump is a rotary- or reciprocating-type pump such as a positive displacement pump operable to displace pressurized fluid. The pump comprises a pump power end, a pump fluid end, and an integration section whereby a reciprocating element (e.g., a plunger) can be mechanically connected with the pump power end such that the reciprocating element can be reciprocated within a reciprocating element bore of the pump fluid end. FIG. 1 is an elevational view (e.g., side view) of a pump 10 (e.g., a reciprocating pump) according to an exemplary embodiment, the reciprocating pump comprising a pump power end 12, a pump fluid end 22, and an integration section 11. As illustrated in FIG. 1, pump fluid end has a front S1 opposite a back S2 along a first or x-axis, a top S3 opposite a bottom S4 along a second or y-axis, wherein the y-axis is in the same plane as and perpendicular to the x-axis, and a left side and a right side along a z-axis, wherein the x-axis is along a plane perpendicular to the plane of the x-axis and the y-axis. Accordingly, toward the top of pump fluid end 22 (and pump 10) is along the y-axis toward top S3, toward the bottom of pump fluid end 22 (and pump 10) is along the y-axis toward bottom S4, toward the front of pump fluid end 22 (and pump 10) is along the x-axis toward front S1, and toward the back of pump fluid end 22 (and pump 10) is along the x-axis away from front S1.

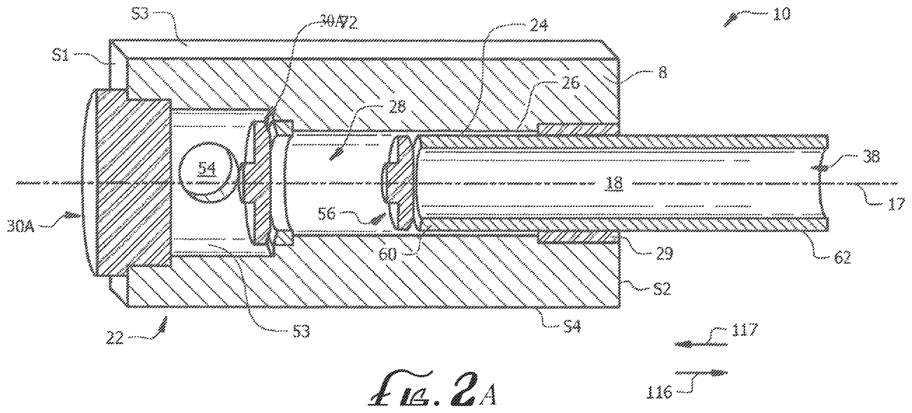

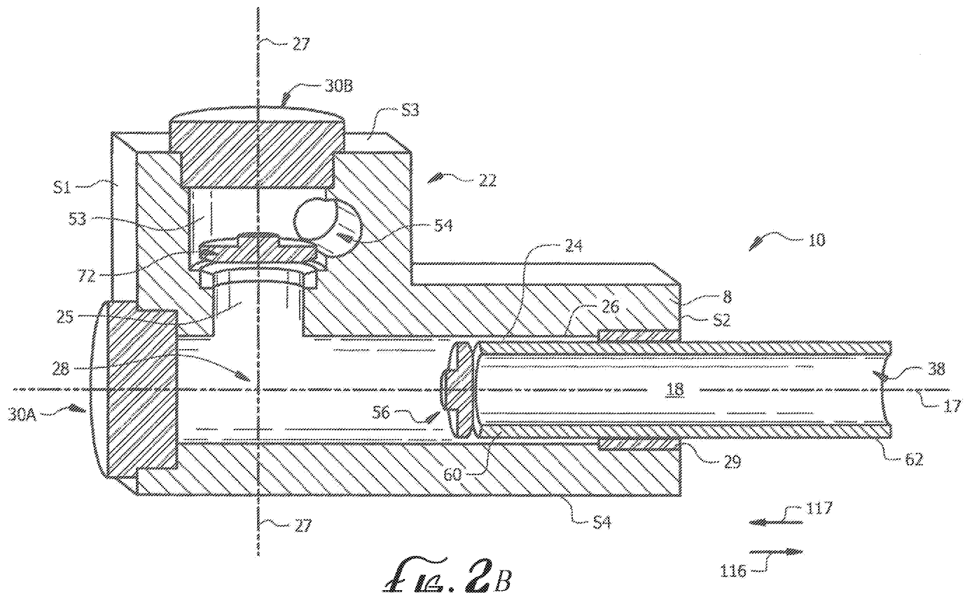

The pump fluid end 22 is integrated with the pump power end 12 via the integration section 11, such that pump power end 12 is operable to reciprocate the reciprocating element 18 within a reciprocating element bore 24 (FIG. 2A/FIG. 2B) of the pump fluid end 22. The reciprocating element bore 24 is at least partially defined by a cylinder wall 26. As described further hereinbelow with reference to FIG. 2A, pump fluid end 22 of this disclosure can be an in-line or “concentric” bore pump fluid end. In alternative embodiments, described further hereinbelow with reference to FIG. 2B, pump fluid end 22 is a “cross-bore” pump fluid end 22 (also referred to herein as a multi-bore pump fluid end), which, as utilized herein, can include “T-bore” pump fluid ends. FIG. 2A is a schematic showing a concentric bore pump fluid end 22 engaged with a reciprocating element 18. FIG. 2B is a schematic showing a tee-bore pump fluid end 22 engaged with a reciprocating element 18. In a tee-bore pump fluid end 22, reciprocating element bore 24 and tee-bore 25 are perpendicular, making the shape of a “T”. As discussed further below, the pump 10 includes at least one fluid inlet 38 for receiving fluid from a fluid source, e.g., a suction line, suction header, storage or mix tank, blender, discharge from a boost pump such as a centrifugal pump, etc. The pump 10 also includes at least one discharge outlet 54 for discharging fluid to a discharge source. e.g., a flowmeter, pressure monitoring and control system, distribution header, discharge line, wellhead, discharge manifold pipe, and the like.

The pump 10 may comprise any suitable pump power end 12 for enabling the pump 10 to perform pumping operations (e.g., pumping a wellbore servicing fluid downhole). Similarly, the pump 10 may include any suitable housing 14 for containing and/or supporting the pump power end 12 and components thereof. The housing 14 may comprise various combinations of inlets, outlets, channels, and the like for circulating and/or transferring fluid. Additionally, the housing 14 may include connections to other components and/or systems, such as, but not limited to, pipes, tanks, drive mechanisms, etc. Furthermore, the housing 14 may be configured with cover plates or entryways for permitting access to the pump power end 12 and/or other pump components. As such, the pump 10 may be inspected to determine whether parts need to be repaired or replaced. The pump power end may also be hydraulically driven, whether it is a non-intensifying or an intensifying system.

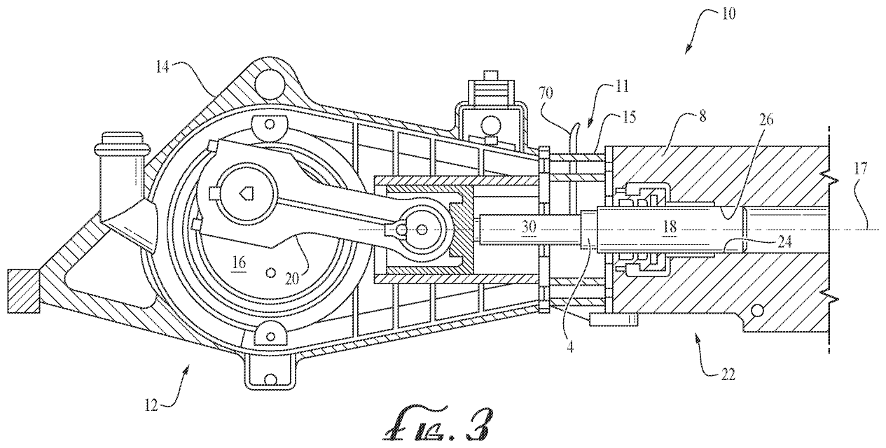

Those versed in the art will understand that the pump power end 12 may include various components commonly employed in pumps. Pump power end 12 can be any suitable pump known in the art and with the help of this disclosure to be operable to reciprocate reciprocating element 18 in reciprocating element bore 24. For example, without limitation, pump power end 12 can be operable via and comprise a crank and slider mechanism, a powered hydraulic/pneumatic/steam cylinder mechanism or various electric, mechanical or electro-mechanical drives. FIG. 3 provides a cutaway illustration of an exemplary pump 10 of this disclosure, showing an exemplary pump power end 12, integrated via integration section 11 with a pump fluid end 22, wherein the pump power end 12 is operable to reciprocate the reciprocating element 18 within a reciprocating element bore 24 of the pump fluid end 22. Briefly, for example, the pump power end 12 may include a rotatable crankshaft 16 attached to at least one reciprocating element 18 (e.g., a plunger or piston) by way of a crank arm 20 and pushrod 30. Additionally, an engine (e.g., a diesel engine), motor, or other suitable power source may be operatively connected to the crankshaft 16 (e.g., through a transmission and drive shaft) and operable to actuate rotation thereof. In operation, rotation of the crankshaft 16 induces translational movement of the crank arm rod 20, thereby causing the reciprocating element 18 to extend and retract along a flow path, which may generally be defined by a central axis 17 within a reciprocating element bore 24 (sometimes referred to herein for brevity as a “reciprocating element bore 24” or simply a “bore 24”, and not wishing to be limited to a particular reciprocating element 18). Pump 10 of FIG. 1 is typically mounted on a movable structure such as a semi-tractor trailer or skid, and the moveable structure may contain additional components, such as a motor or engine (e.g., a diesel engine), that provides power (e.g., mechanical motion) to the pump power end 12 (e.g., a crankcase comprising crankshaft 16 and related connecting rods 20).

Of course, numerous other components associated with the pump power end 12 of the pump 10 may be similarly employed, and therefore, fall within the purview of the present disclosure. Furthermore, since the construction and operation of components associated with pumps of the sort depicted in FIG. 1 are well known and understood, discussion of the pump 10 will herein be limited to the extent necessary for enabling a proper understanding of the disclosed embodiments.

As noted hereinabove, the pump 10 comprises a pump fluid end 22 attached to the pump power end 12. Various embodiments of the pump fluid end 22 are described in detail below in connection with other drawings, for example FIG. 2A and FIG. 2B. Generally, the pump fluid end 22 comprises at least one fluid inlet 38 for receiving fluid, and at least one discharge outlet 54 through which fluid flows out of the discharge chamber 53. The pump fluid end 22 also comprises at least one valve assembly for controlling the receipt and output of fluid. For example, the pump fluid end 22 can comprise a suction valve assembly 56 and a discharge valve assembly 72. The pump fluid end 22 may include any suitable component(s) and/or structure(s) for containing and/or supporting the reciprocating element 18 and providing a cylinder wall 26 at least partially defining a reciprocating element bore 24 along which the pump power end can reciprocate the reciprocating element during operation of the pump.

In embodiments, the pump fluid end 22 may comprise a cylinder wall 26 at least partially defining a bore 24 through which the reciprocating element 18 may extend and retract. Additionally, the bore 24 may be in fluid communication with a discharge chamber 53 formed within the pump fluid end 22. Such a discharge chamber 53, for example, may be configured as a pressurized discharge chamber 53 having a discharge outlet 54 through which fluid is discharged by the reciprocating element 18. Thus, the reciprocating element 18 may be movably disposed within the reciprocating element bore 24, which may provide a fluid flow path into and/or out of the pump chamber. During operation of the pump 10, the reciprocating element 18 may be configured to reciprocate along a path (e.g., along central axis 17 within bore 24 and/or pump chamber 28, which corresponds to reciprocal movement parallel to the x-axis of FIG. 1) to transfer a supply of fluid to the pump chamber 28 and/or discharge fluid from the pump chamber 28.

In operation, the reciprocating element 18 extends and retracts along a flow path to alternate between providing forward strokes (also referred to as discharge strokes and correlating to movement in a positive direction parallel to the x-axis of FIG. 1 and indicated by arrow 117 of FIG. 2A and FIG. 2B) and return strokes (also referred to as suction strokes and correlating to movement in a negative direction parallel to the x-axis of FIG. 1 and indicated by arrow 116 in FIG. 2A and FIG. 2B), respectively. During a forward stroke, the reciprocating element 18 extends away from the pump power end 12 and toward the pump fluid end 22. Before the forward stoke begins, the reciprocating element 18 is in a fully retracted position (also referred to as bottom dead center (BDC) with reference to the crankshaft 16), in which case the suction valve assembly 56 can be in a closed configuration having allowed fluid to flow into the (e.g., high pressure) pump chamber 28. When discharge valve assembly 72 is in a closed configuration (e.g., under the influence of a closing mechanism, such as a spring, the high pressure in a discharge pipe or manifold containing discharge outlet 54) prevents fluid flow into discharge chamber 53 and causes pressure in the pump chamber 28 to accumulate upon stroking of the reciprocating element 18. When the reciprocating element 18 begins the forward or discharge stroke, the pressure builds inside the pump chamber 28 and acts as an opening force that results in positioning of the discharge valve assembly 72 in an open configuration, while a closing force (e.g., via a closing mechanism, such as a spring and/or pressure increase inside pump chamber 28) urges the suction valve assembly 56 into a closed configuration. When utilized in connection with a valve assembly, ‘open’ and ‘closed’ refer, respectively, to a configuration in which fluid can flow through the valve assembly (e.g., can pass between a valve body (e.g., a movable poppet) and a valve seat thereof) and a configuration in which fluid cannot flow through the valve assembly (e.g., cannot pass between a valve body (e.g., a movable poppet) and a valve seat thereof). As the reciprocating element 18 extends forward, fluid within the pump chamber 28 is discharged through the discharge outlet 54.

During a return or suction stroke, the reciprocating element 18 reciprocates or retracts away from the pump fluid end 22 and towards the pump power end 12 of the pump 10. Before the return stroke begins, the reciprocating element 18 is in a fully extended position (also referred to as top dead center (TDC) with reference to the crankshaft 16), in which case the discharge valve assembly 72 can be in a closed configuration having allowed fluid to flow out of the pump chamber 28 and the suction valve assembly 56 is in a closed configuration. When the reciprocating element 18 begins and retracts towards the pump power end 12, the discharge valve assembly 72 assumes a closed configuration, while the suction valve assembly 56 opens. As the reciprocating element 18 moves away from the discharge valve assembly 72 during a return stroke, fluid flows through the suction valve assembly 56 and into the pump chamber 28.

With reference to the embodiment of FIG. 2A, which is a schematic showing a concentric pump fluid end 22 engaged with a reciprocating element 18, concentric bore pump fluid end 22 comprises a concentric bore fluid end body 8, a concentric pump chamber 28, a suction valve assembly 56, and a discharge valve assembly 72. In this concentric bore configuration of FIG. 2A, suction valve assembly 56 and discharge valve assembly 72 are positioned in-line (also referred to as coaxial) with reciprocating element bore 24. i.e., central axis 17 of reciprocating element bore 24 is also the central axis of suction pump assembly 56 and discharge valve assembly 72). With reference to the embodiment of FIG. 2B, which is a schematic showing a T-bore pump fluid end 22 engaged with a reciprocating element 18, T-bore pump fluid end 22 comprises a T-bore fluid end body 8, a T-shaped pump chamber 28, a suction valve assembly 56, and a discharge valve assembly 72. In this T-bore configuration of FIG. 2B, suction valve assembly 56 is coupled with front end 60 of reciprocating element 18 and discharge valve assembly 72 is positioned in bore 25 that makes a tee with reciprocating element bore 24, i.e., central axis 17 of reciprocating element bore 24 is also the central axis of suction pump assembly 56 and perpendicular to a central axis 27 of discharge valve assembly 72).

Suction valve assembly 56 and discharge valve assembly 72 are operable to direct fluid flow within the pump 10. In pump fluid end 22 designs of this disclosure, fluid flows within a hollow reciprocating element (e.g., a hollow plunger) 18 via fluid inlet 38 located toward tail end 62 of reciprocating element 18. The reciprocating element bore 24 of such a fluid end design can be defined by a high pressure cylinder or cylinder wall 26 providing a high pressure chamber. (As utilized here. “high pressure” indicates possible subjection to high pressure during discharge.) When reciprocating element 18 retracts, or moves along central axis 17 in a direction away from the pump chamber 28 and pump fluid end 22 and toward pump power end 12 (as indicated by arrow 116), a suction valve of the suction valve assembly 56 opens (e.g., either under natural flow and/or other biasing means), and a discharge valve of discharge valve assembly 72 will be closed, whereby fluid enters pump chamber 28 via a fluid inlet 38. For a pump fluid end 22 design of this disclosure, the fluid inlet 38 is configured to introduce fluid into pump chamber 28 via a reciprocating element 18 that is hollow. When the reciprocating element 18 reverses direction, due to the action of the pump power end 12, the reciprocating element 18 reverses direction along central axis 17, now moving in a direction toward the pump chamber 28 and pump fluid end 22 and away from pump power end 12 (as indicated by arrow 117), and the discharge valve of discharge valve assembly 72 is open and the suction valve of suction valve assembly 56 is closed (e.g., again either due to fluid flow and/or other biasing means of valve control), such that fluid is pumped out of pump chamber 28 via discharge chamber 53 and discharge outlet 54.

A pump 10 of this disclosure can comprise one or more access ports. With reference to the concentric fluid end body 8 embodiment of FIG. 2A, a front access port 30A can be located on a front S1 of the pump fluid end 22 opposite a back S2 of the pump fluid end 22, wherein the back S2 of the pump fluid end is proximal the pump power end 12, upon integration therewith via integration section 11. With reference to the T-bore fluid end body 8 embodiment of FIG. 2B, a front access port 30A can be located on a front S1 of the pump fluid end 22 opposite a back S2 of the pump fluid end 22, wherein the back S2 of the pump fluid end is proximal the pump power end 12, upon integration therewith via integration section 11, and a top access port 30B can be located on a top S3 of the pump fluid end 22 opposite a bottom S4 of pump fluid end 22. Locations described as front S1, back S2, top S3, and bottom S4 are further described with reference to the x-y-z coordinate system shown in FIG. 1 and further can be relative to a surface (e.g., a trailer bed, the ground, a platform, etc.) upon which the pump 10 is located, a bottom S4 of the pump fluid end being proximal the surface (e.g., trailer bed) upon which the pump 10 is located. Generally, due to size and positioning of pump 10, the front S1 and top S3 of the pump fluid end 22 are more easily accessible than a back S2 or bottom S4 thereof. In a similar manner, a front of pump 10 is distal the pump power end 12 and a back of the pump 10 is distal the pump fluid end 22. The integration section 11 can be positioned in a space between the pump fluid end 22 and the pump power end 12, and can be safeguarded (e.g., from personnel) via a cover 15.

In embodiments, a pump fluid end 22 and pump 10 of this disclosure comprise at least one access port. In embodiments, the at least one access port is located on a side of the discharge valve assembly 72 opposite the suction valve assembly 56. For example, in the concentric bore pump fluid end 22 embodiment of FIG. 2A, front access port 30A is located on a side (e.g., front side) of discharge valve assembly 72 opposite suction valve assembly 56. In the T-bore pump fluid end 22 embodiment of FIG. 2B, front access port 30A is located on top S3 of pump fluid end 22.

In embodiments, one or more seals 29 (e.g., “o-ring” seals, packing seals, or the like), also referred to herein as ‘primary’ reciprocating element packing 29 (or simply “packing 29”) may be arranged around the reciprocating element 18 to provide sealing between the outer walls of the reciprocating element 18 and the inner walls 26 defining at least a portion of the reciprocating element bore 24. In some concentric bore fluid end designs, a second set of seals (also referred to herein as ‘secondary’ reciprocating element packing; not shown in the Figures) may be fixedly arranged around the reciprocating element 18 to provide sealing between the outer walls of the reciprocating element 18 and the inner walls of a low-pressure cylinder that defines the low pressure chamber described hereinabove (e.g., wherein the secondary packing is farther back along the x-axis and delineates a back end of the low pressure chamber that extends from the primary packing 29 to the secondary packing). Skilled artisans will recognize that the seals may comprise any suitable type of seals, and the selection of seals may depend on various factors e.g., fluid, temperature, pressure, etc.

While the foregoing discussion focused on a pump fluid end 22 comprising a single reciprocating element 18 disposed in a single reciprocating element bore 24, it is to be understood that the pump fluid end 22 may include any suitable number of reciprocating elements. As discussed further below, for example, the pump 10 may comprise a plurality of reciprocating elements 18 and associated reciprocating element bores 24 arranged in parallel and spaced apart along the z-axis of FIG. 1 (or another arrangement such as a V block or radial arrangement). In such a multi-bore pump, each reciprocating element bore may be associated with a respective reciprocating element and crank arm, and a single common crankshaft may drive each of the plurality of reciprocating elements and crank arms. Alternatively, a multi-bore pump may include multiple crankshafts, such that each crankshaft may drive a corresponding reciprocating element. Furthermore, the pump 10 may be implemented as any suitable type of multi-bore pump. In a non-limiting example, the pump 10 may comprise a Triplex pump having three reciprocating elements 18 (e.g., plungers or pistons) and associated reciprocating element bores 24, discharge valve assemblies 72 and suction valve assemblies 56, or a Quintuplex pump having five reciprocating elements 18 and five associated reciprocating element bores 24, discharge valve assemblies 72 and suction valve assemblies 56.

Reciprocating element bore 24 can have an inner diameter slightly greater than the outer diameter of the reciprocating element 18, such that the reciprocating element 18 may sufficiently reciprocate within reciprocating element bore 24 (optionally within a sleeve as described herein). In embodiments, the fluid end body 8 of pump fluid end 22 has a pressure rating ranging from about 100 psi to about 3000 psi, or from about 2000 psi to about 10,000 psi, from about 5000 psi to about 30,000 psi, or from about 3000 psi to about 50,000 psi or greater. The fluid end body 8 of pump fluid end 22 may be cast, forged or formed from any suitable materials, e.g., steel, metal alloys, or the like. Those versed in the art will recognize that the type and condition of material(s) suitable for the fluid end body 8 may be selected based on various factors. In a wellbore servicing operation, for example, the selection of a material may depend on flow rates, pressure rates, wellbore service fluid types (e.g., particulate type and/or concentration present in particle laden fluids such as fracturing fluids or drilling fluids, or fluids comprising cryogenic/foams), etc. Moreover, the fluid end body 8 (e.g., cylinder wall 26 defining at least a portion of reciprocating element bore 24 and/or pump chamber 28) may include protective coatings for preventing and/or resisting abrasion, erosion, and/or corrosion.

In embodiments, the cylindrical shape (e.g., providing cylindrical wall(s) 26) of the fluid end body 8 may be pre-stressed in an initial compression. Moreover, a high-pressure cylinder(s) providing the cylindrical shape (e.g., providing cylindrical wall(s) 26) may comprise one or more sleeves (e.g., heat-shrinkable sleeves). Additionally or alternatively, the high-pressure cylinder(s) may comprise one or more composite overwraps and/or concentric sleeves (“over-sleeves”), such that an outer wrap/sleeve pre-loads an inner wrap/sleeve. The overwraps and/or over-sleeves may be non-metallic (e.g., fiber windings) and/or constructed from relatively lightweight materials. Overwraps and/or over-sleeves may be added to increase fatigue strength and overall reinforcement of the components.

The cylinders and cylindrical-shaped components (e.g., providing cylindrical wall 26) associated with the pump fluid end body 8 of pump fluid end 22 may be held in place within the pump 10 using any appropriate technique. For example, components may be assembled and connected, e.g., bolted, welded, etc. Additionally or alternatively, cylinders may be press-fit (e.g., interference fit) into openings machined or cast into the pump fluid end 22 or other suitable portion of the pump 10. Such openings may be configured to accept and rigidly hold cylinders (e.g., having cylinder wall(s) 26 at least partially defining reciprocating element bore 24) in place so as to facilitate interaction of the reciprocating element 18 and other components associated with the pump 10.

In embodiments, the reciprocating element 18 comprises a plunger or a piston. While the reciprocating element 18 may be described herein with respect to embodiments comprising a plunger, it is to be understood that the reciprocating element 18 may comprise any suitable component for displacing fluid. In a non-limiting example, the reciprocating element 18 may be a piston. As those versed in the art will readily appreciate, a piston-type pump generally employs sealing elements (e.g., rings, packing, etc.) attached to the piston and movable therewith. In contrast, a plunger-type pump generally employs fixed or static seals (e.g., primary seal or packing 29) through which the plunger moves during each stroke (e.g., suction stroke or discharge stroke).

As skilled artisans will understand, the reciprocating element 18 may include any suitable size and/or shape for extending and retracting along a flow path within the pump fluid end 22. For instance, reciprocating element 18 may comprise a generally cylindrical shape, and may be sized such that the reciprocating element 18 can sufficiently slide against or otherwise interact with the inner cylinder wall 26. In embodiments, one or more additional components or mechanical linkages 4 (FIG. 3; e.g., clamps, adapters, extensions, etc.) may be used to couple the reciprocating element 18 to the pump power end 12 (e.g., to a pushrod 30).

In some embodiments (e.g. T-bore pump fluid end 22 embodiments such as FIG. 2B), the reciprocating element 18 may be substantially solid and/or impermeable (e.g., not hollow). In some embodiments, reciprocating element 18 employed in a concentric bore pump fluid end 22 embodiment (such as depicted in FIG. 2A) or a cross-bore pump fluid end 22 (such as depicted in FIG. 2B) comprises a peripheral wall defining a hollow body. Additionally (e.g., concentric bore pump fluid end 22 embodiments such as FIG. 2A), a portion of the peripheral wall of reciprocating element 18 may be generally permeable or may include an input through which fluid may enter the hollow body and an output through which fluid may exit the hollow body. Furthermore, while the reciprocating element 18 may, in embodiments, define a substantially hollow interior and include a ported body, a base of the reciprocating element 18 proximal the pump power end, when assembled, may be substantially solid and/or impermeable (e.g., a plunger having both a hollow portion and a solid portion).

The reciprocating element 18 comprises a front or free end 60. In embodiments comprising concentric bore pump fluid end designs 22 such as shown in FIG. 2A, the reciprocating element 18 can contain or at least partially contain the suction valve assembly 56. In embodiments, the suction valve assembly 56 is at least partially disposed within the reciprocating element 18 at or proximate to the front end 60 thereof. At an opposite or tail end 62 (also referred to as back or tail end 62) of the reciprocating element 18, the reciprocating element 18 may include a base coupled to the pump power end 12 of the pump 10 (e.g., via crank arm 20). In embodiments, the tail end 62 of the reciprocating element 18 is coupled to the pump power end 12 outside of pump fluid end 22. e.g., within integration section 11.

As noted above, pump fluid end 22 contains a suction valve assembly 56. Suction valve assembly 56 may alternately open or close to permit or prevent fluid flow. Skilled artisans will understand that the suction valve assembly 56 may be of any suitable type or configuration (e.g., gravity- or spring-biased, flow activated, etc.). Those versed in the art will understand that the suction valve assembly 56 may be disposed within the pump fluid end 22 at any suitable location therein. For instance, the suction valve assembly 56 may be disposed within reciprocating element bore 24 and at least partially within reciprocating element 18 in concentric bore pump fluid end 22 designs such as FIG. 2A or T-bore pump fluid end 22 designs such as FIG. 2B, such that a suction valve body of the suction valve assembly 56 moves away from a suction valve seat within the a suction valve seat housing of reciprocating element 18 when the suction valve assembly 56 is opening and toward the suction valve seat when the suction valve assembly 56 is closing.

Pump 10 comprises a discharge valve assembly 72 for controlling the output of fluid through discharge chamber 53 and discharge outlet 54. Analogous to the suction valve assembly 56, the discharge valve assembly 72 may alternately open or close to permit or prevent fluid flow. Those versed in the art will understand that the discharge valve assembly 72 may be disposed within the pump chamber at any suitable location therein. For instance, the discharge valve assembly 72 may be disposed proximal the front S1 of bore 24 (e.g., at least partially within discharge chamber 53 and/or pump chamber 28) of the pump fluid end 22, such that a discharge valve body of the discharge valve assembly 72 moves toward the discharge chamber 53 when the discharge valve assembly 72 is in an open configuration and away from the discharge chamber 53 when the discharge valve assembly 72 is in a closed configuration. In addition, in concentric bore pump fluid end 22 configurations such as FIG. 2A, the discharge valve assembly 72 may be co-axially aligned with the suction valve assembly 56 (e.g., along central axis 17), and the suction valve assembly 56 and the discharge valve assembly 72 may be coaxially aligned with the reciprocating element 18 (e.g., along central axis 17). In alternative embodiments, such as the T-bore pump fluid end 22 embodiment of FIG. 2B, discharge valve assembly 72 can be positioned within T-bore 25, at least partially within discharge chamber 53 and/or pump chamber 28, and have a central axis coincident (e.g., coaxial) with central axis 27 of T-bore 25.

Further, the suction valve assembly 56 and the discharge valve assembly 72 can comprise any suitable mechanism for opening and closing valves. For example, the suction valve assembly 56 and the discharge valve assembly 72 can comprise a suction valve spring and a discharge valve spring, respectively. Additionally, any suitable structure (e.g., valve assembly comprising sealing rings, stems, poppets, etc.) and/or components may be employed suitable means for retaining the components of the suction valve assembly 56 and the components of the discharge valve assembly 72 within the pump fluid end 22 may be employed.

The fluid inlet 38 may be arranged within any suitable portion of the pump fluid end 22 and configured to supply fluid to the pump in any direction and/or angle. Moreover, the pump fluid end 22 may comprise and/or be coupled to any suitable conduit (e.g., pipe, tubing, or the like) through which a fluid source may supply fluid to the fluid inlet 38. The pump 10 may comprise and/or be coupled to any suitable fluid source for supplying fluid to the pump via the fluid inlet 38. In embodiments, the pump 10 may also comprise and/or be coupled to a pressure source such as a boost pump (e.g., a suction boost pump) fluidly connected to the pump 10 (e.g., via inlet 38) and operable to increase or “boost” the pressure of fluid introduced to pump 10 via fluid inlet 38. A boost pump may comprise any suitable type including, but not limited to, a centrifugal pump, a gear pump, a screw pump, a roller pump, a scroll pump, a piston/plunger pump, or any combination thereof. For instance, the pump 10 may comprise and/or be coupled to a boost pump known to operate efficiently in high-volume operations and/or may allow the pumping rate therefrom to be adjusted. Skilled artisans will readily appreciate that the amount of added pressure may depend and/or vary based on factors such as operating conditions, application requirements, etc. In embodiments, the boost pump may have an outlet pressure greater than or equal to about 70 psi, about 80 psi, or about 110 psi, providing fluid to the suction side of pump 10 at about said pressures. Additionally or alternatively, the boost pump may have a flow rate of greater than or equal to about 80 BPM, about 70 BPM, and/or about 50 BPM.

As noted hereinabove, the pump 10 may be implemented as a multi-cylinder pump comprising multiple cylindrical reciprocating element bores 24 and corresponding components. In embodiments, the pump 10 is a Triplex pump in which the pump fluid end 22 comprises three reciprocating assemblies, each reciprocating assembly comprising a suction valve assembly 56, a discharge valve assembly 72, a pump chamber 28, a fluid inlet 38, a discharge outlet 54, and a reciprocating element bore 24 within which a corresponding reciprocating element 18 reciprocates during operation of the pump 10 via connection therewith to a (e.g., common) pump power end 12. In embodiments, the pump 10 is a Quintuplex pump in which the pump fluid end 22 comprises five reciprocating assemblies. In a non-limiting example, the pump 10 may be a Q-10™ Quintuplex Pump or an HT-400™ Triplex Pump, produced by Halliburton Energy Services, Inc.

In embodiments, the pump fluid end 22 may comprise an external manifold (e.g., a suction header) for feeding fluid to the multiple reciprocating assemblies via any suitable inlet(s). Additionally or alternatively, the pump fluid end 22 may comprise separate conduits such as hoses fluidly connected to separate inlets for inputting fluid to each reciprocating assembly. Of course, numerous other variations may be similarly employed, and therefore, fall within the scope of the present disclosure.

Those skilled in the art will understand that the reciprocating elements of each of the reciprocating assemblies may be operatively connected to the pump power end 12 of the pump 10 according to any suitable manner. For instance, separate connectors (e.g., cranks arms/connecting rods 20, one or more additional components or mechanical linkages 4, pushrods 30, etc.) associated with the pump power end 12 may be coupled to each reciprocating element body or tail end 62. The pump 10 may employ a common crankshaft (e.g., crankshaft 16) or separate crankshafts to drive the multiple reciprocating elements.

As previously discussed, the multiple reciprocating elements may receive a supply of fluid from any suitable fluid source, which may be configured to provide a constant fluid supply. Additionally or alternatively, the pressure of supplied fluid may be increased by adding pressure (e.g., boost pressure) as described previously. In embodiments, the fluid inlet(s) 38 receive a supply of pressurized fluid comprising a pressure ranging from about 30 psi to about 300 psi.

Additionally or alternatively, the one or more discharge outlet(s) 54 may be fluidly connected to a common collection point such as a sump or distribution manifold, which may be configured to collect fluids flowing out of the fluid outlet(s) 54, or another cylinder bank and/or one or more additional pumps.

During pumping, the multiple reciprocating elements 18 will perform forward and returns strokes similarly, as described hereinabove. In embodiments, the multiple reciprocating elements 18 can be angularly offset to ensure that no two reciprocating elements are located at the same position along their respective stroke paths (i.e., the plungers are “out of phase”). For example, the reciprocating elements may be angularly distributed to have a certain offset (e.g., 120 degrees of separation in a Triplex pump) to minimize undesirable effects that may result from multiple reciprocating elements of a single pump simultaneously producing pressure pulses. The position of a reciprocating element is generally based on the number of degrees a pump crankshaft (e.g., crankshaft 16) has rotated from a bottom dead center (BDC) position. The BDC position corresponds to the position of a fully retracted reciprocating element at zero velocity, e.g., just prior to a reciprocating element moving (i.e., in a direction indicated by arrow 117 in FIGS. 2A and 2B) forward in its cylinder. A top dead center position corresponds to the position of a fully extended reciprocating element at zero velocity. e.g., just prior to a reciprocating element moving backward (i.e., in a direction indicated by arrow 116 in FIGS. 2A and 2B) in its cylinder.

As described above, each reciprocating element 18 is operable to draw in fluid during a suction (backward or return) stroke and discharge fluid during a discharge (forward) stroke. Skilled artisans will understand that the multiple reciprocating elements 18 may be angularly offset or phase-shifted to improve fluid intake for each reciprocating element 18. For instance, a phase degree offset (at 360 degrees divided by the number of reciprocating elements) may be employed to ensure the multiple reciprocating elements 18 receive fluid and/or a certain quantity of fluid at all times of operation. In one implementation, the three reciprocating elements 18 of a Triplex pump may be phase-shifted by a 120-degree offset. Accordingly, when one reciprocating element 18 is at its maximum forward stroke position, a second reciprocating element 18 will be 60 degrees through its discharge stroke from BDC, and a third reciprocating element will be 120 degrees through its suction stroke from top dead center (TDC).

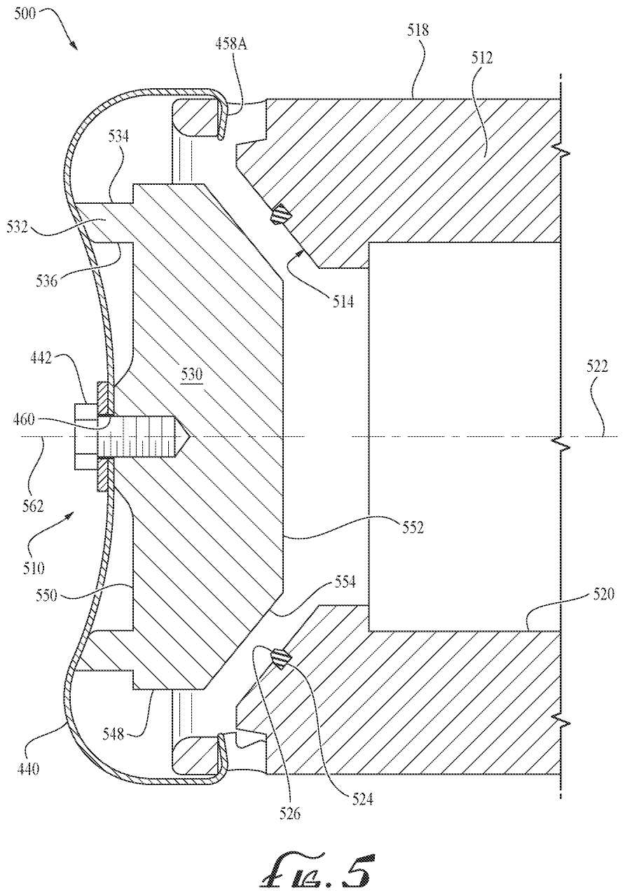

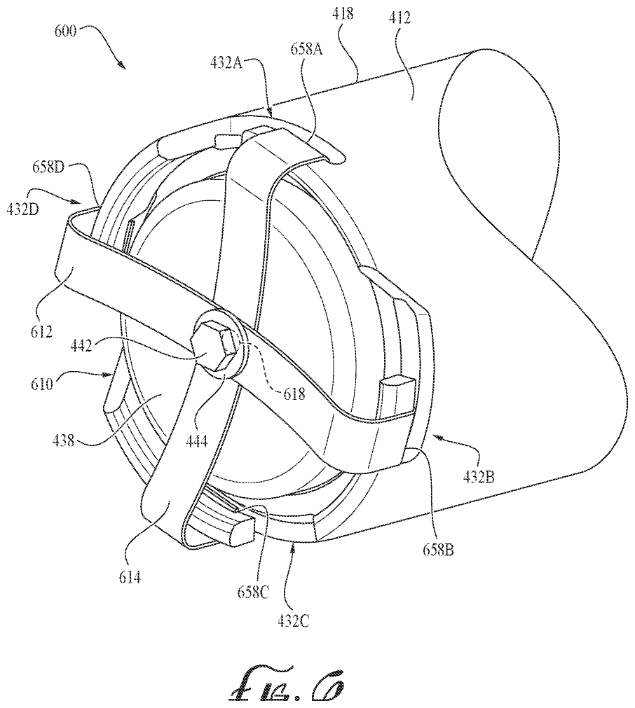

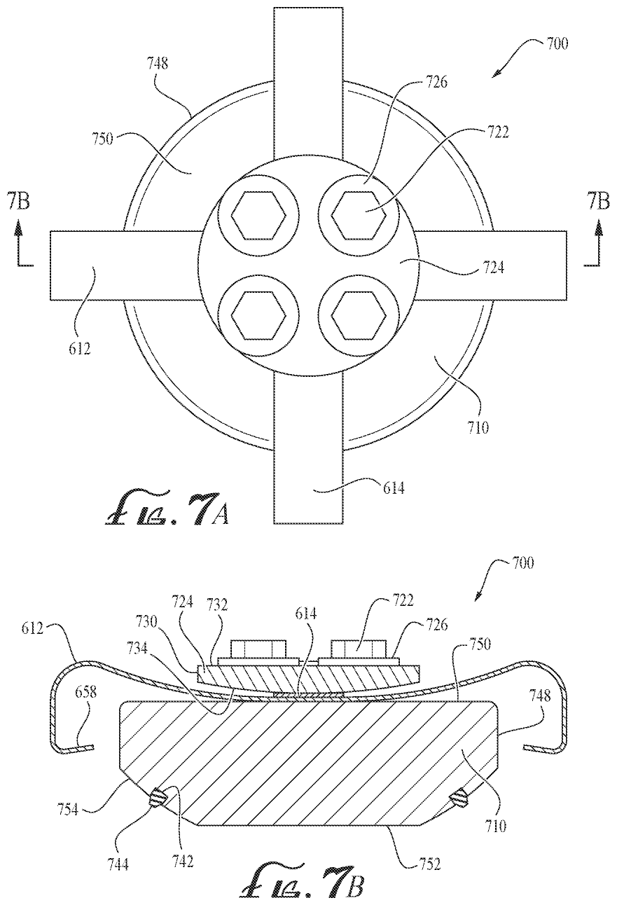

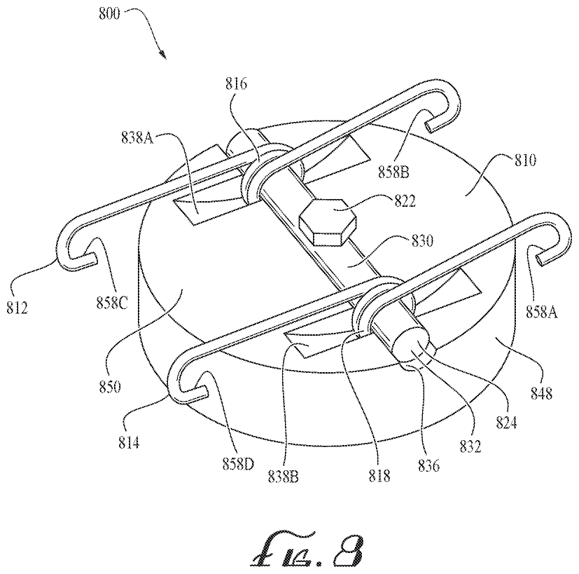

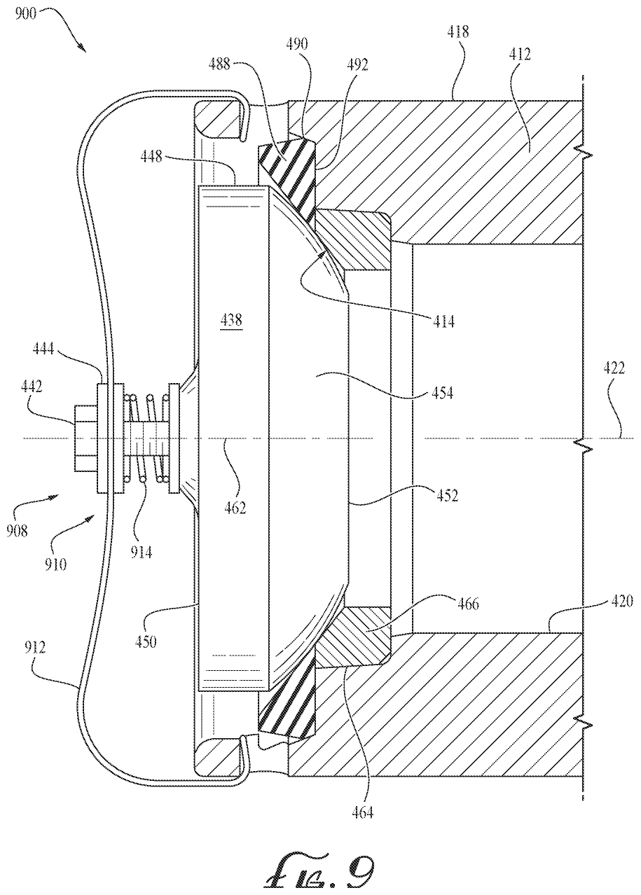

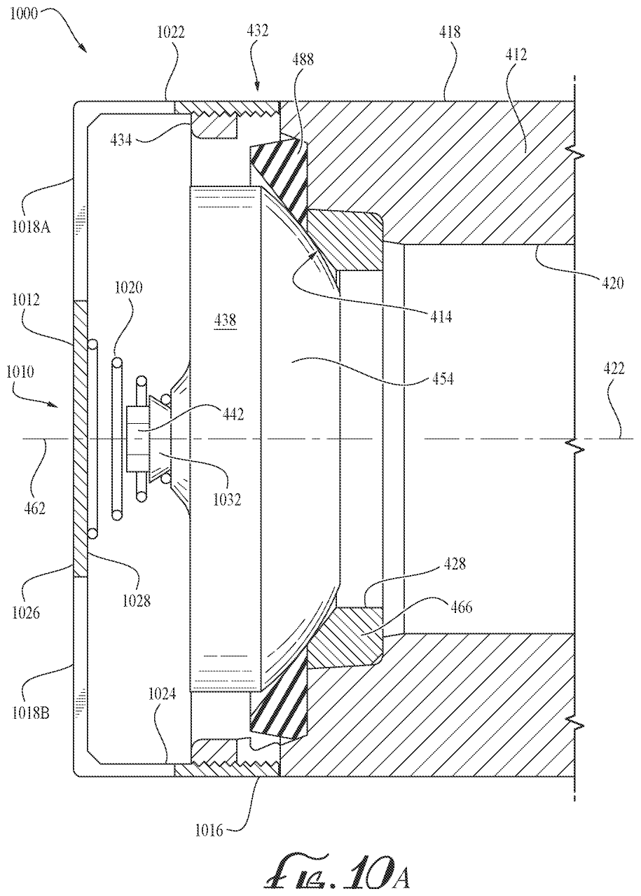

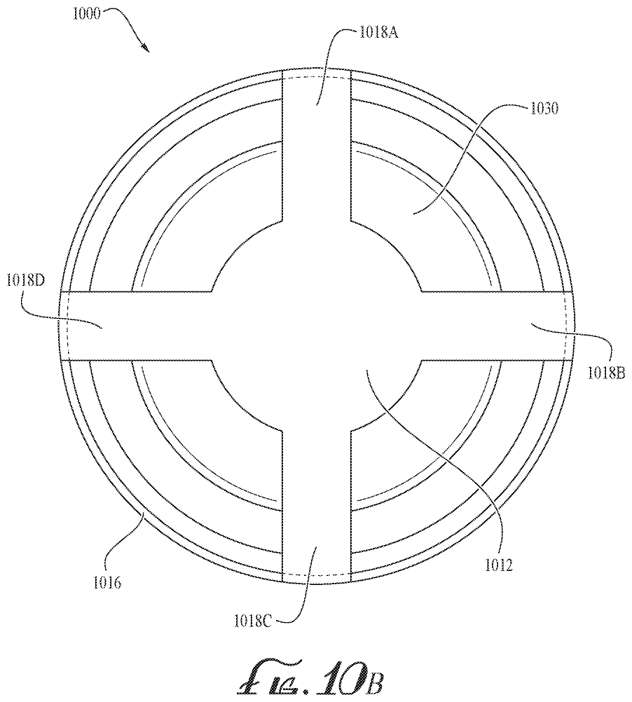

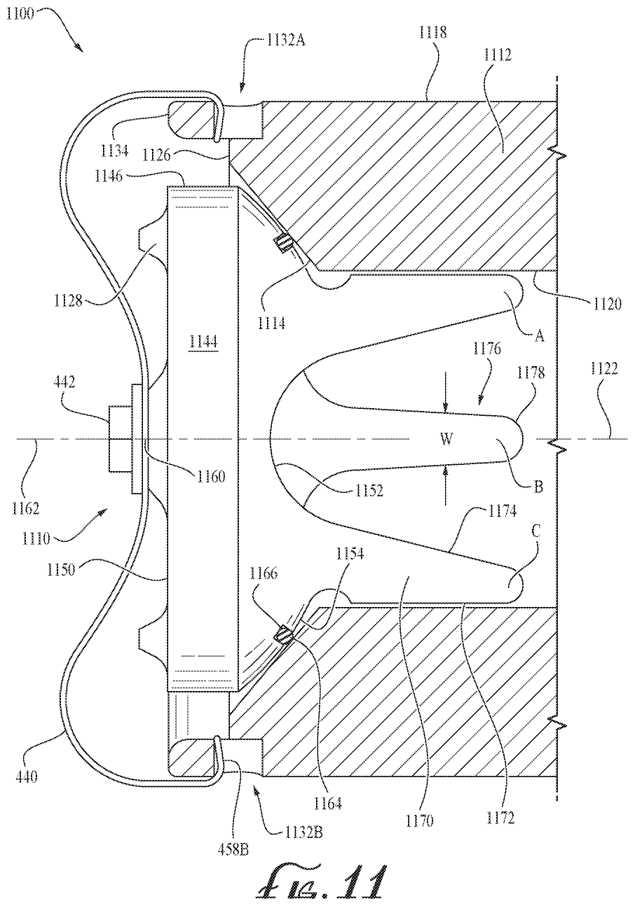

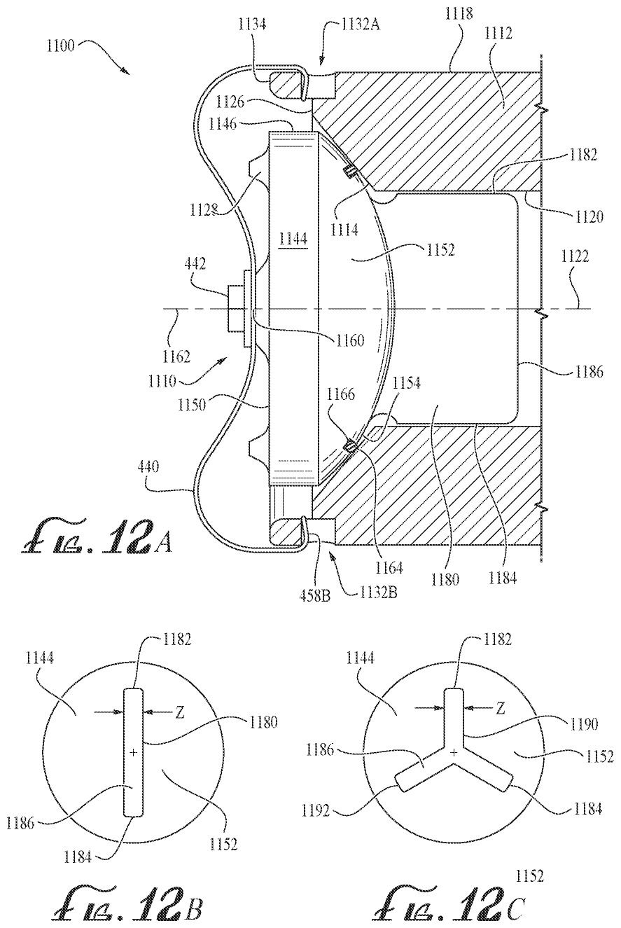

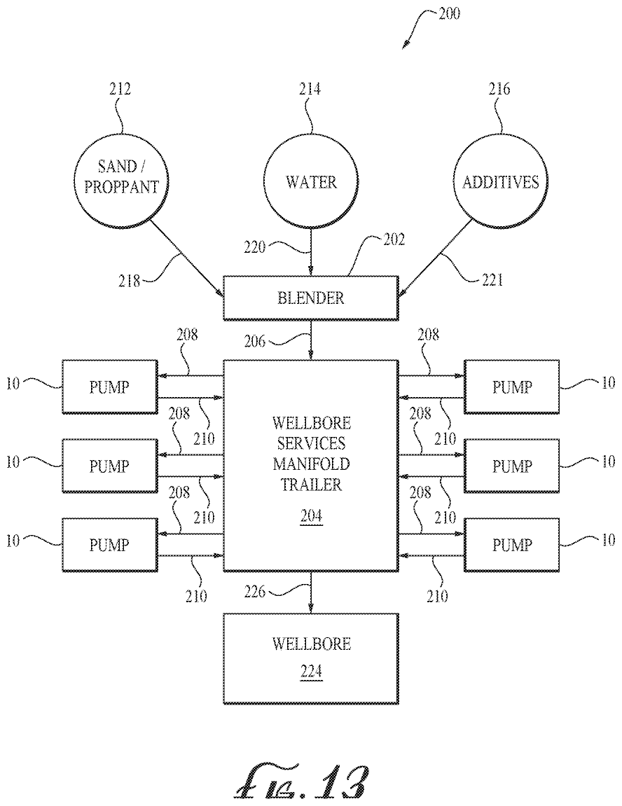

According to this disclosure, and as described further herein, a horizontal valve assembly comprises a valve body, and a valve alignment device, wherein the valve alignment device has an urging and alignment feature distributed about the valve body of the valve assembly. The horizontal aligned valve assembly can be coupled to the reciprocating device or to a valve retainer on the reciprocating device. FIG. 4A is a partial cross-sectional view of a horizontal aligned valve assembly 100 having a valve alignment feature coupled to the reciprocating device, in a closed configuration. FIG. 5 is a partial cross-sectional view of horizontal valve assembly 500, in an open configuration according to an embodiment of the present disclosure, wherein the valve body has an alignment limiting feature. FIG. 6 is an isometric view of a horizontal valve assembly 600 in the closed position according to an embodiment of the present disclosure, wherein the alignment feature comprises multiple valve alignment devices. FIG. 7B is a partial cross-sectional view of an alignment feature coupled to a valve body according to an embodiment of the present disclosure. FIG. 8 is an isometric view of an alignment feature coupled to a valve body according to an embodiment of the present disclosure. FIG. 9 is a partial cross-sectional view of an alignment feature coupled to a valve body according to an embodiment of the present disclosure. FIG. 10 is a partial cross-sectional view of an alignment feature coupled to a valve body according to an embodiment of the present disclosure. FIG. 11 is a partial cross-sectional view of horizontal aligned valve assembly 1100, in a closed configuration, according to an embodiment of the present disclosure. FIG. 12 is a partial cross-sectional view of horizontal aligned valve assembly 1100, in a closed configuration, according to an embodiment of the present disclosure.

Referring to FIG. 4A, a horizontal valve assembly 400 comprises a valve body assembly 410 disposed within a valve housing 412 with a valve seat 414 also referred to as a valve seat contact surface. As illustrated, the valve body assembly 410 can be in a closed configuration wherein a portion of the valve body forms a seal with the valve seat 414. As previously described, the horizontal aligned valve assembly can be in the closed position during the discharge motion (e.g., arrow 117) of the reciprocating element 18 of FIGS. 2A and 2B. The valve housing 412 can be an embodiment of the reciprocating element 18 of FIGS. 2A and 2B. The valve housing 412 can be a generally cylinder shape with an outer surface 418, an inner surface 420, and a central axis 422, e.g., longitudinal axis. The inner surface 420 of the valve housing 412 can define a flow bore also referred to as a fluid inlet 38 in FIGS. 2A and 2B. The valve seat contact surface 414 can be a frustoconical shape extending from an end surface 426 to an inner surface 428. The circumference of the inner surface 428 of the valve seat may be less than, equal to, or greater than the circumference of the inner surface 420 of the valve housing 412. An engagement feature 432 can be located proximal to the end face 434 of the valve housing 412. The engagement feature 432 can be in the form of a port, a closed slot, an open slot, or a threaded surface. As illustrated, the engagement feature 432 can be an engagement slot as will be described further herein. In some embodiments, the valve seat 414. e.g., valve seat contact surface, can include a portion with a seal member, e.g., an elastomeric seal. In some embodiments, the valve seat, e.g., valve seat contact surface 414, can include a portion with a hardened seating member, e.g., a portion of the valve seat made from hardened material.

The valve body assembly 410 can comprise a valve body 438, a spring member 440, and a retaining device 442. The retaining device 442 can be a fastener, e.g., a bolt, with a retainer spacer 444. The valve body 438 can be a circular plate shape revolved about a center axis 462 with an outer surface 448, a discharge end surface 450, an inlet end surface 452, and a valve seat contact surface 454. The center axis 462 of the valve body 438 can be coincident with the central axis 422 of the valve housing 412. The inlet end surface 452 of the valve body 438 can face into the flow bore of the valve housing 412. The discharge end surface 450 can face or be oriented towards the discharge side of the valve body 438. The valve seat contact surface 454 can form a seal, e.g., a metal-to-metal seal, with the valve seat contact surface 414 of the valve housing 412. In some embodiments, the valve seat contact surface 414 can include a seal member, e.g., an elastomeric seal. In some embodiments, the valve seat contact surface 454 can include a seal member, e.g., an elastomeric seal.

The spring member 440 can be a single spring configured to align and urge the valve body 438 onto the valve seat 414. As illustrated in FIG. 4A, the spring member 440 can be a flat spring formed into a bow shape. e.g., the shape of an archery bow, with an attachment end 458 at each end, e.g., near end and far end, of the spring member 440. The spring member 440 can be coupled to the discharge side of the valve body 438 by an attachment feature 460. For example, the attachment feature 460 can be a port through which a retaining device 442 and retainer spacer 444 couple the spring member 440 to the valve body 438. The spring member 440 can couple the attachment end 458 to the engagement feature 432 of the valve housing 412. The spring member 440 can have an attachment end 458A and 458B coupled to corresponding engagement features 432A and 432B. The spring member 440 can be configured to bias or urge the valve body 438 onto the valve seat 414 in the closed position. The spring member 440 can have a low level of spring stress corresponding to the installed configuration of the closed position. Although the spring member 440 is illustrated as a single wire shape extending from engagement feature 432A to engagement feature 432B, it is understood that the spring member could have multiple wire shapes, e.g., 2, 3, 4, 5, 6, 7, 8 or any number thereof, extending from the attachment feature 460 to corresponding engagement features 432.

In some embodiments, the spring member 440 can be a cantilever spring coupled to the housing 412 in one location. For example, the spring member 440 can be coupled to the discharge side of the valve body 438 by an attachment feature 460 and coupled to the housing 412 to a single engagement feature 432 of the valve housing 412. The cantilever type spring member 440 can be configured to align and urge the valve body 438 onto the valve seat 414.

Turning now to FIG. 4B, the horizontal valve assembly 400 is illustrated in the open position. As previously described, the valve body assembly 410 can be in the open position, e.g., valve body 438 separated from the valve seat 414, during the return motion (e.g., arrow 116) of the reciprocating element 18 of FIGS. 2A and 2B. The axial travel A of the valve body 438 away from the valve seat 414 can increase the spring stress level of the spring member 440, thus the biasing force towards the valve seat 414 is greater in the open position than the closed position. The spring member 440 can align the valve body 438 with the valve seat 414. The spring member 440 can comprise an upper portion 440A and a lower portion 440B. The upper portion 440A can extend from the attachment feature 460 to the attachment end 458A coupled to the engagement feature 432A. The lower portion 440B can extend from the attachment feature 460 to the attachment end 458B coupled to the engagement feature 432B. The mass of the valve body 438 can apply a tension force to the upper portion 440A and a compression force to the lower portion 440B of the spring member 440. The formed shape, e.g., bow shape, of the spring member 440 and the spring stress within the spring member 440 can counteract the applied tension and compression forces to retain the center axis 462 of the valve body 438 in alignment with the central axis 422 of the valve housing 412.

In an embodiment, the valve housing 412, as illustrated in FIG. 4B can comprise a hardened seat 466. The hardened seat 466 can be ring shaped with a frustoconical surface 468 coincident with the valve seat 414. The valve seat contact surface can comprise a housing portion 470A and a seat portion 470B. The hardened seat 466 can be coupled to an inner seat surface 464 of the valve housing 412. The hardened seat 466 can be configured to protect the valve seat 414 from erosion via the erosive fluids and impingement damage from the valve seat contact surface 454.

In some embodiments, the horizontal valve assembly 400 can be oriented in a non-horizontal position. Referring to FIGS. 2A and 2B, the cylinder 24 and reciprocating element 18 within the fluid end 22 can be oriented at any angle between 0 degrees (e.g., horizontal) and 90 degrees (e.g., vertical). Thus, the centerline of the cylinder 422 (an embodiment of the reciprocating element 18) can be oriented at any angle between 0 to 90 degrees. In some embodiments, the horizontal valve assembly 400 can be an embodiment of the discharge valve 72. The horizontal valve assembly 400 can be discharge valve 72 of FIG. 2A that is oriented horizontally or the discharge valve 72 of FIG. 2B that is oriented vertically.

Turning now to FIG. 5, a horizontal valve assembly 500 is illustrated in the open position. In some embodiments, the valve body assembly 510 can include a spring limiter feature configured to change the spring rate of the spring member 440. The valve body assembly 510 comprises a valve body 530, a spring member 440, and a retaining device 442. The valve assembly 500 may share parts and features similar to valve assembly 400 and share the same reference numbers. The valve body 530 can be a circular plate shape revolved about a center axis 562 with an outer surface 548, a chamber end surface 550, a cylinder end surface 552, and a valve contact surface 554. The center axis 562 of the valve body 530 can be coincident with the central axis 522 of the valve housing 512. The valve body 530 can have a travel limiter 532. e.g., a protrusion in the shape of a ring, extending from the chamber end surface 550 with an outer surface 534 and an inner surface 536. The travel limiter 532 can be configured to contact the spring member 440 on the side of the spring member 440 facing the chamber end surface 550 of the valve body 530. The travel limited 532 can change the spring rate of the spring member 440 by effectively changing the spring length. The normal spring rate can be based on the spring member length measured from the attachment feature 460 to the attachment end 458A. The modified spring rate can be based on the spring length measured from the travel limiter 532 to the attachment end 458A. The travel limiter 532 can prevent the spring member 440 from damage due to spring stress by changing the spring rate at a predetermined axial travel distance determined by the height of the protrusion from the chamber end surface 550.

In some embodiments, valve seat 514 of the valve housing 512 can include a seat seal 526. The valve housing 512 can be generally cylinder shape with an outer surface 518, an inner surface 520, a valve seat 514, and a central axis 522. The valve seat 514 can be frustoconical in shape and can include a circumferential groove 524. The valve seat 514 can include a seat seal 526 disposed within the circumferential groove 524. The seat seal 526 can be made from a thermoplastic material or elastomeric material and configured to form a seal with the valve contact surface 554 of the valve body 530. In some embodiments, the valve seat 514 can comprise a hardened seat 466. In some embodiments, the valve seat 514 can comprise a portion of the valve seat surface with an elastomeric seal and a portion with a hardened seat surface.

In some embodiments, the horizontal valve assembly 500 can be oriented in a non-horizontal position. Referring to FIGS. 2A and 2B, the cylinder 24 and reciprocating element 18 within the fluid end 22 can be oriented at any angle between 0 degrees (e.g., horizontal) and 90 degrees (e.g., vertical). Thus, the centerline of the cylinder 522 (an embodiment of the reciprocating element 18) can be oriented at any angle between 0 to 90 degrees. In some embodiments, the horizontal valve assembly 500 can be an embodiment of the discharge valve 72. The horizontal valve assembly 500 can be discharge valve 72 of FIG. 2A that is oriented horizontally or the discharge valve 72 of FIG. 2B that is oriented vertically.

Turning now to FIG. 6, a horizontal valve assembly 600 is illustrated in the closed position. In some embodiments, the valve assembly 610 can include a first spring member 612 and a second spring member 614 coupled to the valve body 438 by a retaining device 442. The valve assembly 600 may share parts and features similar to valve assembly 400 and 500 and thus, share the same reference numbers. The first spring member 612 and second spring member 614 can have the same spring rate or different spring rates. For example, the first spring member 612 can have a spring rate higher than, equal to, or lower than the spring rate of the second spring member 614. The first spring member 612 can couple to the valve housing 412 at the engagement features 432B and 432D with corresponding attachment end 658B and 658D. The second spring member 614 can couple to the valve housing 412 at the engagement features 432A and 432C with corresponding attachment end 658A and 658C. In some embodiments, the valve body 438 can have a travel limiting feature, for example, travel limiter 532. In some embodiments, the travel limiter 532 can vary in height and be configured to contact the first spring member 612 before contacting the second spring member 614 or vice versa.

In some embodiments, the first spring member 612 and the second spring member 614 can be a cantilever spring coupled to the housing 412 in one location. For example, the first spring member 612 and the second spring member 614 can be coupled to the discharge side of the valve body 438 by an attachment feature 618 and coupled to the housing 412 to a first single engagement feature 658B and a second single engagement feature 658A of the valve housing 412. The cantilever type first spring member 612 and second spring member 614 can be configured to align and urge the valve body 438 onto the valve seat 414.

Turning now to FIGS. 7A and 7B, a top view and cross-sectional view of a valve assembly 700 is described. In some embodiments, the valve assembly 700 can include a first spring member 612 and a second spring member 614 coupled to the valve body 710 by an attachment device 724 and at least one retaining device 722. The valve assembly 700 may share parts and features similar to valve assembly 400, 500, and 600 and thus, share the same reference numbers. The valve body 710 can be a circular plate shape with an outer surface 748, a chamber end surface 750, a cylinder end surface 752, and a valve seat contact surface 754. The valve seat contact surface 754 can be a frustoconical shape or a spherical shape. The spring members 612 and 614 can be coupled to the valve body 710 by the attachment device 724. The attachment device 724 can be a generally plate shape with an outer surface 730, an end surface 732, a spring member surface 734 and ports for the retaining device 722. The retaining device 722 can be fasteners, e.g., bolts, installed with devices 726 through the ports in the attachment device 724 and coupling to the valve body 710. Referring to FIG. 7A, attachment device 724 may have a retaining device 722 on each side of each spring member to secure the spring members with the attachment device 724 and the valve body 710. The spring members 612 and 614 are coupled to the valve body 710 with the attachment device 724 instead of with an attachment feature 618, e.g., a port. The spring member surface 734 of the attachment device 724 can be curved, beveled, or otherwise configured to allow for flexure of the spring members 612 and 614. As previously disclosed, the first spring member 612 and second spring member 614 can have the same spring rate or different spring rates. In some embodiments, the valve body 710 can have a sealing means. For example, the valve body 710 can have a valve seal 744 inside a circumferential groove 742. In some embodiments, the valve body 710 can have a travel limiting feature, for example, travel limiter 532.

Turning now to FIG. 8, an isometric view of a horizontal valve assembly 800 is described. In some embodiments, the valve assembly 800 can include a first spring member 812 and a second spring member 814 coupled to the valve body 810 by an attachment device 824 and at least one retaining device 822. The valve assembly 800 may share parts and features similar to valve assembly 400, 500, 600 and 700 and thus, share the same reference numbers. The valve body 810 can be a circular plate shape with an outer surface 848, a discharge end surface 850, a cylinder end surface, and a valve contact surface (not shown). The spring members 812 and 814 can be coupled to the valve body 810 by the attachment device 824. The attachment device 824 can be a generally rod shape with an outer surface 830, an end surface 832, and a port for the retaining device 822. The retaining device 822 can be a fastener. e.g., bolts, installed through the port in the attachment device 824 and coupled to the valve body 810. The attachment device 824 may fit into a groove 836 on the discharge end surface 850. The spring members 612 and 614 can be torsion type springs with torsion spring wraps 818 installed into a first groove 838A and second groove 838B on the discharge end surface 850. The attachment device 824 can be located within the torsion spring wraps 818 of each spring. The spring members 812 and 814 can be coupled to the valve body 810 by the attachment device 824 holding the torsion spring wraps 818 of each spring in the corresponding groove 838A and 838B. Each spring can have an attachment end 858A-D that couples to a corresponding engagement feature 432A-D of the valve housing 412.

Turning now to FIG. 9, an partial cross-sectional view of a valve body assembly 900 is described. A horizontal aligned valve assembly 900 comprises a valve body assembly 908 disposed within a valve housing 412 with a valve seat 414, e.g., a valve seat contact surface. The valve body assembly 908 can comprise a valve body 438, a progressive spring member 910, and a retaining device 442. The retaining device 442 can be a fastener. e.g., a bolt, with a retainer spacer 444. The valve body 438 can be a circular plate shape revolved about a center axis 462 with an outer surface 448, a discharge end surface 450, an inlet end surface 452, and a valve seat contact surface 454. The valve seat contact surface 454 can be a curved shape, e.g., a spherical contour. The progressive spring 910 comprises a first spring member 912 and a second spring member 914. The first spring member 912 can be formed from flat spring material into a bow shape. The second spring member 914 can be a compression spring formed of round wire, square wire, or other similarly shaped wire wound in a helical wrap. During operation, the second spring member 914 can deflect to allow the valve to open with a low amount of force, e.g., opening pressure. In contrast, the first spring member 912 can deflect with a large amount of force, e.g. large opening pressure. The combination of low spring rate spring and high spring rate spring can allow the valve to partially open in response to low pressure and fully open in response to operational pressures, e.g., higher pressures. The spring rate of the first spring member 912 can be greater than, equal to, or less than the spring rate of the second spring member 914. The center axis 462 of the valve body 438 can be coincident with the central axis 422 of the valve housing 412.

The valve housing 412 can be a generally cylinder shape with an outer surface 418, an inner surface 420, and a central axis 422, e.g., longitudinal axis. In some embodiments, the valve seat 414, e.g., valve seat contact surface, can be frustoconical in shape and include a portion with a seat seal 488, e.g., an elastomeric seal. The seat seal 488 can be installed within an inner surface 490 and abutting a seal face 492 of the valve housing 412. In some embodiments, the valve seat. e.g., valve seat contact surface 414, can include a portion with a hardened seat 466, e.g., a portion of the valve seat made from hardened material, in a frustoconical shape.

Referring to FIG. 10, a horizontal aligned valve assembly 1000 comprises a valve body assembly 1010 disposed within a valve housing 412 with a valve seat 414. The valve body assembly 1010 can comprise a retaining cap 1012, a valve body 438, a spring member 1020, and a retaining device 442. The retaining cap 1012 can be generally cylindrical in shape with a portion referred to as a spring plate 1014 and a retention ring 1016. The retaining cap 1012 can have an outer surface 1022, an inner surface 1024, an end face 1026, and an inner face 1028. The inner surface 1024 of the retention ring 1016 can be threaded. A set of arms 1018 can be formed between flow ports 1030. The spring plate 1014 can be connected to a retention ring 1016 via at least two arms 1018A and 1018B. Although four arms 1018 are illustrated, it is understood that the retaining cap 1012 can have 1, 2, 3, 4, 5, 6, 7, 8, 9, or any number of arms 1018. The spring member 1020 can be a compression spring wound in a conical shape. The spring member 1020 can be coupled to the valve body 438 via a retaining device 442 and a conical shaped retainer spacer 1032. The spring member 1020 can be coupled to the spring plate 1014 portion of the retaining cap 1012. The valve body 438 can be a circular plate shape revolved about a center axis 462 with an outer surface 448, a discharge end surface 450, an inlet end surface 452, and a valve seat contact surface 454. The center axis 462 of the valve body 438 can be coincident with the central axis 422 of the valve housing 412. As illustrated, the valve body assembly 1010 can be in a closed configuration wherein a portion of the valve body forms a seal with a portion of the valve seat 414 comprising the seat seal 488, the hardened seat 466, or both.

As previously described, the valve housing 412 can be a generally cylinder shape with an outer surface 418, an inner surface 420, and a central axis 422, e.g., longitudinal axis. The valve seat contact surface 414 can be a frustoconical shape with a seat seal 488, e.g., an elastomeric seal, and a hardened seat 466. The circumference of the inner surface 428 of the hardened seat 466 may be less than, equal to, or greater than the circumference of the inner surface 420 of the valve housing 412. An engagement feature 432 in the form of a threaded surface can be located proximal to the end face 434 of the valve housing 412. As illustrated, the engagement feature 432 can mechanically couple the retention ring 1016. In some embodiments, the valve seat 414, e.g., valve seat contact surface, can include a portion with a seal member, e.g., an elastomeric seal. In some embodiments, the valve seat. e.g., valve seat contact surface 414, can include a portion with a hardened seating member, e.g., a portion of the valve seat made from hardened material.

Turning now to FIG. 11, a horizontal aligned valve assembly 1100 is described. In some embodiments, the valve assembly 1100 comprises a valve body assembly 1110 disposed within a valve housing 1112 with a valve seat 1114. The valve body assembly 1010 can comprise a valve body 1144, a spring member 440, and a retaining device 442. The valve body 1144 can be a cylinder shape with a center axis 1162 with an outer surface 1146, a discharge end surface 1150, an inlet end surface 1152, and a valve seat contact surface 1154. The center axis 462 of the valve body 1144 can be coincident with the central axis 422 of the valve housing 1112. In some embodiments, the valve body 1144 comprises a travel limiter 1128 in the ring shape protruding from the discharge end surface 1150 of the valve body 1144. The travel limiter 1128 can be configured to contact the inner surface of the spring member 440 to change the spring rate of the spring member 440 and limit the axial travel of the valve body 1144. The valve seat contact surface 1154 can be spherical, e.g., curved, shape and can form a seal, e.g., a metal-to-metal seal, with the valve seat contact surface 1114 of the valve housing 1112. In some embodiments, the valve seat contact surface 1154 can include a seal member 1164. e.g., an elastomeric seal, disposed in a circumferential groove 1166. In some embodiments, the valve seat contact surface 1114 can include a seal member, e.g., an elastomeric seal.

The valve housing 1112 can be an embodiment of the reciprocating element 18 of FIGS. 2A and 2B. The valve housing 1112 can be a generally cylinder shape with an outer surface 1118, an inner surface 1120, and a central axis 1122, e.g., longitudinal axis. The valve seat contact surface 1114 can be a frustoconical shape extending from an end surface 1126 to the inner surface 1120. An engagement feature 432 can be located proximal to the end face 434 of the valve housing 412. The engagement feature 1132 can be in the form of a port, a closed slot, an open slot, or a threaded surface. As illustrated, the engagement feature 1132 can be an engagement slot as will be described further herein. In some embodiments, the valve seat 1114, e.g., valve seat contact surface, can include a portion with a seal member, e.g., an elastomeric seal. In some embodiments, the valve seat. e.g., valve seat contact surface 1114, can include a portion with a hardened seating member, e.g., a portion of the valve seat made from hardened material.

In some embodiments, the valve body 1144 can include an alignment or guide structure extending axially from valve seat contact surface 1154 an axial distance (e.g., a distance along central axis 1122, e.g., equal to or greater than 0.5, 1, 1.5, 2, 2.5, 3, 3.5 or 4 inches) and having one or more (e.g., 2, 3, 4, 5, 6, or more) contact surfaces configured about parallel to and in sliding engagement with the inner surface 1120 of the valve housing 1112.

As shown in FIG. 11, the guide structure can be in the shape of fingers or wings 1170 protruding from the inlet end surface 1152. The guide structure or wings 1170 can be formed with an outer surface 1172, an inner surface 1174, and a wing width W. The outer surface 1172 can include a sliding allowance fit to the inner surface 1120 of the valve housing 1112. The inner surface 1174 can extend from the inlet end surface 1152 to the tip end 1178 of each wing 1170. The length of each wing 1170, e.g., from the inlet end surface 1152 to the tip end 1178, can be configured to allow the outer surface 1172 of the wing 1170 to remain within the bore, e.g., the inner surface 1120, of the valve housing 1112 at the maximum deflection of the spring member 440. The wings 1170A-C of the valve body 1144 can be configured to align the center axis 1162 of the valve body 1144 with the central axis 1122 of the valve housing 1112 and thus, align the valve seat contact surface 1154 with the valve seat 1114. Although three wings 1170A-C are illustrated, it is understood that the valve body 1144 can have 2.3, 4, 5, 6 or any number of wings 1170.

In some embodiments, the valve body 1144 can include a guide structure in the shape of blades or fins protruding from the inlet end surface 1152. Turning to FIG. 12A-C, the blade shape of the guide structure can be a thin planar shape 1180 with a first outer surface 1182, a second outer surface 1184, and a blade width Z. The first outer surface 1182, e.g., first guiding surface, and second outer surface 1184, e.g., second guiding surface, can include a sliding allowance fit to the inner surface 1120 of the valve housing 1112. The blade structure 1180 can extend from the inlet end surface 1152 to the end face 1186 of each blade structure 1180. The length of each blade structure 1180, e.g., from the inlet end surface 1152 to the end face 1186, can be configured to allow the guiding surface 1182 of the blade shape to remain within the bore. e.g., the inner surface 1120, of the valve housing 1112 at the maximum deflection of the spring member 440. The blade structure 1180 of the valve body 1144 can be configured to align the center axis 1162 of the valve body 1144 with the central axis 1122 of the valve housing 1112 and thus, align the valve seat contact surface 1154 with the valve seat 1114. Although the guide structure of a single blade structure 1180 with an outer surface 1182 and outer surface 1184 is illustrated, it is understood that the valve body 1144 can have 2, 3, 4, 5, 6 or any number of guiding surfaces. For example, as shown in FIG. 12C, the guiding structure in the shape of blade shape 1190 of the valve body 1114 can comprise a first guiding surface 1182, a second guiding surface 1184, a third guiding surface 1192, and each guiding surface can have a blade width Z.

As previously described, the spring member 440 can be a single spring configured to align and urge the valve body 1144 onto the valve seat 1114. As illustrated in FIG. 11 and FIG. 12, the spring member 440 can be a flat spring formed into a bow shape with an attachment end 458 at each end. The spring member 440 can be coupled to the valve body 114 by a retaining device 442, e.g., a bolt, and a retainer spacer 444. e.g., a washer. The spring member 440 can couple the attachment end 458 to the engagement feature 1132 of the valve housing 1112. The spring member 440 can have an attachment end 458A and 458B coupled to corresponding engagement features 432A and 432B. The spring member 440 can be configured to bias or urge the valve body 1144 onto the valve seat 1114 in the closed position. The spring member 440 can have a low level of spring stress corresponding to the installed configuration of the closed position. Although the spring member 440 is illustrated as a single wire shape extending from engagement feature 432A to engagement feature 432B, it is understood that the spring member could have multiple wire shapes, e.g., 2, 3, 4, 5, 6, 7, 8 or any number thereof, extending from the attachment feature 1160 to corresponding engagement features 1132.

In some embodiments, the horizontal valve assembly 600/1100 can be oriented in a non-horizontal position. Referring to FIGS. 2A and 2B, the cylinder 24 and reciprocating element 18 within the fluid end 22 can be oriented at any angle between 0 degrees (e.g., horizontal) and 90 degrees (e.g., vertical). Thus, the centerline of the cylinder 622/1122 (an embodiment of the reciprocating element 18) can be oriented at any angle between 0 to 90 degrees. In some embodiments, the horizontal valve assembly 600/1100 can be an embodiment of the discharge valve 72. The horizontal valve assembly 600/1100 can be discharge valve 72 of FIG. 2A that is oriented horizontally or the discharge valve 72 of FIG. 2B that is oriented vertically.

Also disclosed herein is a pump fluid end 22 comprising a horizontal valve assembly 400, 500, 600, 700, 800, 900, 1000, or 1100 (also referred to as 400/1100) of this disclosure, and a pump 10 comprising the pump fluid end 22. In embodiments, the pump fluid end 22 comprises the valve assembly (400/1100) in an assembled configuration in which valve seat 414 is seated in valve housing 412, and valve body 438 is coupled to engagement feature 432 of the valve housing 412 via a spring member 440. Spring member 440 is positioned outside of the flow bore (e.g., inner surface 420) of valve housing 412 and on the discharge side of the valve body 438.

In embodiments, a pump fluid end 22 of this disclosure comprises a suction valve assembly 56 and/or a discharge valve assembly 72 comprising the valve assembly 400/1100. In embodiments wherein the discharge valve assembly 72 comprises a valve assembly 400/1100, the valve seat 414 is a discharge valve seat, the valve body 438 is a discharge valve body, and the spring member 440 is a discharge valve spring, and, when the discharge valve assembly 72 is in an assembled configuration, the discharge valve seat is seated in a discharge valve seat housing, the discharge valve body is coupled to the discharge valve seat housing via the spring member, and the discharge valve spring is positioned outside of a bore of the discharge valve seat housing. In embodiments wherein the suction valve assembly 56 comprises a valve assembly 400/1100, the valve seat 414 is a suction valve seat, and the valve body 438 is a suction valve body, and, when the suction valve assembly 56 is in an assembled configuration in which the suction valve seat is seated in a suction valve seat housing, the suction valve body is coupled to the suction valve housing via the spring member, and the suction valve spring is positioned outside of a bore of the suction valve seat housing.

A pump fluid end 22 of this disclosure can be a cross-bore pump fluid end 22 or a concentric bore pump fluid end 22. In embodiments, the pump fluid end 22 comprising a valve assembly 400/1100 of this disclosure as suction valve assembly 56, is a cross-bore pump fluid end 22 such as a T-bore pump fluid end (e.g., of the type shown in FIG. 2B and described in detail herein) comprising a fluid end body 8 comprising a T-bore pump chamber 28, a cylindrical reciprocating element bore 24, partially defined by cylinder walls 26, in which a reciprocating element 18 can reciprocate during operation of a pump comprising the pump fluid end 22, the reciprocating element 18, and a pump power end 12 (FIG. 3), and a cylindrical T-bore 25 comprising a suction valve assembly 56 and a discharge valve assembly 72.

In some such T-bore pump fluid end embodiments, suction valve assembly 56 comprises a valve assembly 400/1100 of this disclosure. In this T-bore embodiment, suction valve seat housing 65 is positioned within an interior of fluid end body 8 and can comprise a part of an interior surface within T-bore 25 on a side of central axis 17 opposite that of discharge valve assembly 72 (e.g., a recess or channel within T-bore 25 located proximate the right side of T-bore 25). For example, in embodiments, the discharge valve assembly 72 is positioned coaxially above the suction valve assembly 56 within cross-bore 25. In embodiments, the suction valve assembly 56 comprising a valve assembly 400/1100 of this disclosure is positioned within a reciprocating element bore 24 of the pump fluid end 22, wherein the reciprocating element bore 24 is perpendicular to the tee-bore 25.

In embodiments, the pump fluid end 22 is a concentric bore pump fluid end, such as depicted in FIG. 2A. The discharge valve assembly 72 comprises a valve assembly 400/1100 of this disclosure, and is positioned at least partially within the reciprocating element bore 24 and is coaxially aligned with the suction valve assembly 56. In embodiments, the suction valve assembly 56 comprises a valve assembly 400/1100 of this disclosure and a valve seat, and the reciprocating element 18 is at least partially hollow and has a front end 60 opposite a tail end 62 along a central axis of the reciprocating element bore 24, and the suction valve assembly 56 is coupled with the front end of the reciprocating element 18. The reciprocating element 18 can be a plunger. In embodiments, the horizontal valve assembly 400/1100 has a central axis 17 that is about coaxial with a central axis of the reciprocating element bore 24.

Also disclosed herein is a pump 10 comprising a pump fluid end 22 of this disclosure. The pump of this disclosure comprises a pump power end 12 (e.g., as described with reference to FIG. 3, hereinabove) and a pump fluid end 22. The pump power end 12 is operable to reciprocate the reciprocating element 18 within a reciprocating element bore 24 of the pump fluid end 22. As described hereinabove, the pump fluid end 22 comprises: the reciprocating element 18, a suction valve assembly 56, and a discharge valve assembly 72. Reciprocating element 18 is disposed at least partially within the reciprocating element bore 24, and has a front end 60 opposite a tail end 62 along a central axis 17 of the reciprocating element bore 24. According to this disclosure, the suction valve assembly 56 of pump 10 is coupled with the front end 60 of the reciprocating element 18. In embodiments, the pump is a positive displacement pump comprising a valve assembly 400/1100 of this disclosure, and the valve guide of the valve assembly 400/1100 has a central axis that is about coaxial with a central axis of a plunger of the positive displacement pump.

In embodiments, the pump fluid end 22 of the pump 10 is a concentric bore pump fluid end 22, such as depicted in the embodiment of FIG. 2A, and the discharge valve assembly 72 is positioned at least partially within the reciprocating element bore 24 and is coaxially aligned with the suction valve assembly 56. In embodiments, the pump fluid end 22 of the pump 10 is a tee-bore pump fluid end 22, such as depicted in the embodiment of FIG. 2B, and the discharge valve assembly 72 is positioned within a tee-bore 25 of the pump fluid end 22, wherein the tee-bore 25 is perpendicular to the reciprocating element bore 24.

A pump 10 of this disclosure can be a multiplex pump comprising a plurality of reciprocating assemblies (e.g., reciprocating elements 18, and a corresponding plurality of reciprocating element bores 24, suction valve assemblies 56, and discharge valve assemblies 72). The plurality can comprise any number such as, for example, 2, 3, 4, 5, 6, 7, or more. For example, in embodiments, pump 10 is a triplex pump, wherein the plurality comprises three. In alternative embodiments, pump 10 comprises a Quintuplex pump, wherein the plurality comprises five.

The pump 10 can be an oilfield services pump configured to pump a wellbore servicing fluid. Examples of wellbore servicing fluids suitable include, but are not limited to, cementitious fluids (e.g., cement slurries), drilling fluids or muds, spacer fluids, fracturing fluids or completion fluids, and gravel pack fluids, remedial fluids, perforating fluids, sealants, drilling fluids, completion fluids, diverter fluids, gelation fluids, polymeric fluids, aqueous fluids, oleaginous fluids, etc. The pump 10 can be used in oilfield and/or well servicing operations which include, but are not limited to, drilling operations, fracturing operations, perforating operations, fluid loss operations, primary cementing operations, secondary or remedial cementing operations, or any combination of operations thereof.

A pump with a aligned valve assembly (hereinafter also referred to as a first valve assembly) that is not a valve assembly of this disclosure can be serviced to become a pump of this disclosure (hereinafter also referred to as a serviced pump). The first valve assembly can be changed (e.g., replaced, retrofitted) into a valve assemble of this disclosure (hereinafter also referred to as a second valve assembly). The second valve assembly can be a new valve assembly from the first valve assembly or a retrofit of the first valve assembly. For example, the first valve assembly can be a valve assembly 400 as in FIG. 4A having a spring member coupled to the valve body 438. The second valve assembly can be any of the valve assembly of this disclosure (e.g., a valve assembly 400/1100 in any of FIGS. 4-11). The second valve assembly can be a retrofit of the first valve assembly. The retrofit can involve decoupling the spring member from the valve housing, removing the first valve assembly, and coupling the spring member of the new valve assembly to the valve housing.

A method of servicing a pump can comprise: increasing or decreasing the spring rate of the spring member on a valve assembly in the pump, wherein the valve assembly is a aligned valve assembly. The first valve assembly can stay in or be taken out of the pump 10 while the spring member is being changed. The first valve assembly can be accessed from any of the one or more access ports of the pump 10, for instance, a front access port 30A and/or a top access port 30B.

In embodiments, the first valve assembly is replaced by a second valve assembly that has a different spring rate. The method can further comprise: removing a first aligned valve assembly from the pump, wherein the first valve assembly comprises a valve body and a spring member; and installing a second aligned valve assembly in the pump, wherein the second valve assembly comprises a valve body and a spring member and wherein the second valve assembly has a different spring member with the same or different spring rate.

In embodiments, the methods as disclosed hereinabove further comprise operating the serviced pump to place a wellbore servicing fluid in a wellbore. The method of using the pump in servicing a wellbore will be described hereinbelow.

Disclosed herein are a method of servicing a wellbore and a wellbore servicing system 200 comprising a pump of this disclosure. An embodiment of a wellbore servicing system 200 and a method of servicing a wellbore via the wellbore servicing system 200 will now be described with reference to FIG. 13, which is a schematic representation of an embodiment of a wellbore servicing system 200, according to embodiments of this disclosure.

A method of servicing a wellbore 224 according to this disclosure comprises fluidly coupling a pump 10 of this disclosure to a source of a wellbore servicing fluid and to the wellbore, and communicating wellbore servicing fluid into the wellbore via the pump. The method can further comprise discontinuing the communicating of the wellbore servicing fluid into the wellbore via the pump, subjecting the pump to maintenance to provide a maintained pump, and communicating the or another wellbore servicing fluid into the wellbore via the maintained pump. Subjecting the pump to maintenance can comprise servicing the pump 10, as described hereinabove. During operation of a pump 10 of this disclosure, central axis 17A of the valve guide is coincident with central axis 17B of the valve body 33 and central axis 17 of pump fluid end 22.

It will be appreciated that the wellbore servicing system 200 disclosed herein can be used for any purpose. In embodiments, the wellbore servicing system 200 may be used to service a wellbore 224 that penetrates a subterranean formation by pumping a wellbore servicing fluid into the wellbore and/or subterranean formation. As used herein, a “wellbore servicing fluid” or “servicing fluid” refers to a fluid used to drill, complete, work over, fracture, repair, or in any way prepare a well bore for the recovery of materials residing in a subterranean formation penetrated by the well bore. It is to be understood that “subterranean formation” encompasses both areas below exposed earth and areas below earth covered by water such as ocean or fresh water. Examples of servicing fluids suitable for use as the wellbore servicing fluid, the another wellbore servicing fluid, or both include, but are not limited to, cementitious fluids (e.g., cement slurries), drilling fluids or muds, spacer fluids, fracturing fluids or completion fluids, and gravel pack fluids, remedial fluids, perforating fluids, sealants, drilling fluids, completion fluids, diverter fluids, gelation fluids, polymeric fluids, aqueous fluids, oleaginous fluids, etc.

In embodiments, the wellbore servicing system 200 comprises one or more pumps 10 operable to perform oilfield and/or well servicing operations. Such operations may include, but are not limited to, drilling operations, fracturing operations, perforating operations, fluid loss operations, primary cementing operations, secondary or remedial cementing operations, or any combination of operations thereof. Although a wellbore servicing system is illustrated, skilled artisans will readily appreciate that the pump 10 disclosed herein may be employed in any suitable operation.

In embodiments, the wellbore servicing system 200 may be a system such as a fracturing spread for fracturing wells in a hydrocarbon-containing reservoir. In fracturing operations, wellbore servicing fluids, such as particle laden fluids, are pumped at high-pressure into a wellbore. The particle laden fluids may then be introduced into a portion of a subterranean formation at a sufficient pressure and velocity to cut a casing and/or create perforation tunnels and fractures within the subterranean formation. Proppants, such as grains of sand, are mixed with the wellbore servicing fluid to keep the fractures open so that hydrocarbons may be produced from the subterranean formation and flow into the wellbore. Hydraulic fracturing may desirably create high-conductivity fluid communication between the wellbore and the subterranean formation.

The wellbore servicing system 200 comprises a blender 202 that is coupled to a wellbore services manifold trailer 204 via flowline 206. As used herein, the term “wellbore services manifold trailer” includes a truck and/or trailer comprising one or more manifolds for receiving, organizing, and/or distributing wellbore servicing fluids during wellbore servicing operations. In this embodiment, the wellbore services manifold trailer 204 is coupled to six positive displacement pumps (e.g., such as pump 10 that may be mounted to a trailer and transported to the wellsite via a semi-tractor) via outlet flowlines 208 and inlet flowlines 210. In alternative embodiments, however, there may be more or less pumps used in a wellbore servicing operation. Outlet flowlines 208 are outlet lines from the wellbore services manifold trailer 204 that supply fluid to the pumps 10. Inlet flowlines 210 are inlet lines from the pumps 10 that supply fluid to the wellbore services manifold trailer 204.

The blender 202 mixes solid and fluid components to achieve a well-blended wellbore servicing fluid. As depicted, sand or proppant 212, water 214, and additives 216 are fed into the blender 202 via feedlines 218, 220, and 221, respectively. The water 214 may be potable, non-potable, untreated, partially treated, or treated water. In embodiments, the water 214 may be produced water that has been extracted from the wellbore while producing hydrocarbons form the wellbore. The produced water may comprise dissolved and/or entrained organic materials, salts, minerals, paraffins, aromatics, resins, asphaltenes, and/or other natural or synthetic constituents that are displaced from a hydrocarbon formation during the production of the hydrocarbons. In embodiments, the water 214 may be flowback water that has previously been introduced into the wellbore during wellbore servicing operation. The flowback water may comprise some hydrocarbons, gelling agents, friction reducers, surfactants and/or remnants of wellbore servicing fluids previously introduced into the wellbore during wellbore servicing operations.

The water 214 may further comprise local surface water contained in natural and/or manmade water features (such as ditches, ponds, rivers, lakes, oceans, etc.). Still further, the water 214 may comprise water stored in local or remote containers. The water 214 may be water that originated from near the wellbore and/or may be water that has been transported to an area near the wellbore from any distance. In some embodiments, the water 214 may comprise any combination of produced water, flowback water, local surface water, and/or container stored water. In some implementations, water may be substituted by nitrogen or carbon dioxide; some in a foaming condition.

In embodiments, the blender 202 may be an Advanced Dry Polymer (ADP) blender and the additives 216 are dry blended and dry fed into the blender 202. In alternative embodiments, however, additives may be pre-blended with water using other suitable blenders, such as, but not limited to, a GEL PRO blender, which is a commercially available preblender trailer from Halliburton Energy Services. Inc., to form a liquid gel concentrate that may be fed into the blender 202. The mixing conditions of the blender 202, including time period, agitation method, pressure, and temperature of the blender 202, may be chosen by one of ordinary skill in the art with the aid of this disclosure to produce a homogeneous blend having a desirable composition, density, and viscosity. In alternative embodiments, however, sand or proppant, % water, and additives may be premixed and/or stored in a storage tank before entering a wellbore services manifold trailer 204.

In embodiments, the pump(s) 10 (e.g., pump(s) 10 and/or maintained pump(s) 10) pressurize the wellbore servicing fluid to a pressure suitable for delivery into a wellbore 224 or wellhead. For example, the pumps 10 may increase the pressure of the wellbore servicing fluid (e.g. the wellbore servicing fluid and/or the another wellbore servicing fluid) to a pressure of greater than or equal to about 10.000 psi, 20,000 psi, 30.000 psi, 40,000 psi, or 50,000 psi, or higher.

From the pumps 10, the wellbore servicing fluid may reenter the wellbore services manifold trailer 204 via inlet flowlines 210 and be combined so that the wellbore servicing fluid may have a total fluid flow rate that exits from the wellbore services manifold trailer 204 through flowline 226 to the wellbore 224 of between about 1 BPM to about 200 BPM, alternatively from between about 50 BPM to about 150 BPM, alternatively about 100 BPM. in embodiments, each of one or more pumps 10 discharge wellbore servicing fluid at a fluid flow rate of between about 1 BPM to about 200 BPM, alternatively from between about 50 BPM to about 150 BPM, alternatively about 100 BPM. Persons of ordinary skill in the art with the aid of this disclosure will appreciate that the flowlines described herein are piping that are connected together for example via flanges, collars, welds, etc. These flowlines may include various configurations of pipe tees, elbows, and the like. These flowlines connect together the various wellbore servicing fluid process equipment described herein.

Also disclosed herein are methods for servicing a wellbore (e.g., wellbore 224). Without limitation, servicing the wellbore may include: positioning the wellbore servicing composition in the wellbore 224 (e.g., via one or more pumps 10 as described herein) to isolate the subterranean formation from a portion of the wellbore; to support a conduit in the wellbore; to plug a void or crack in the conduit; to plug a void or crack in a cement sheath disposed in an annulus of the wellbore; to plug a perforation; to plug an opening between the cement sheath and the conduit; to prevent the loss of aqueous or nonaqueous drilling fluids into loss circulation zones such as a void, vugular zone, or fracture; to plug a well for abandonment purposes; to divert treatment fluids; and/or to seal an annulus between the wellbore and an expandable pipe or pipe string. In other embodiments, the wellbore servicing systems and methods may be employed in well completion operations such as primary and secondary cementing operation to isolate the subterranean formation from a different portion of the wellbore.

In embodiments, a wellbore servicing method may comprise transporting a positive displacement pump (e.g., pump 10) to a site for performing a servicing operation. Additionally or alternatively, one or more pumps may be situated on a suitable structural support. Non-limiting examples of a suitable structural support or supports include a trailer, truck, skid, barge or combinations thereof. In embodiments, a motor or other power source for a pump may be situated on a common structural support.

In embodiments, a wellbore servicing method may comprise providing a source for a wellbore servicing fluid. As described above, the wellbore servicing fluid may comprise any suitable fluid or combinations of fluid as may be appropriate based upon the servicing operation being performed. Non-limiting examples of suitable wellbore servicing fluid include a fracturing fluid (e.g., a particle laden fluid, as described herein), a perforating fluid, a cementitious fluid, a sealant, a remedial fluid, a drilling fluid (e.g., mud), a spacer fluid, a gravel pack fluid, a diverter fluid, a gelation fluid, a polymeric fluid, an aqueous fluid, an oleaginous fluid, an emulsion, various other wellbore servicing fluid as will be appreciated by one of skill in the art with the aid of this disclosure, and combinations thereof. The wellbore servicing fluid may be prepared on-site (e.g., via the operation of one or more blenders) or, alternatively, transported to the site of the servicing operation.

In embodiments, a wellbore servicing method may comprise fluidly coupling a pump 10 to the wellbore servicing fluid source. As such, wellbore servicing fluid may be drawn into and emitted from the pump 10. Additionally or alternatively, a portion of a wellbore servicing fluid placed in a wellbore 224 may be recycled. i.e., mixed with the water stream obtained from a water source and treated in fluid treatment system. Furthermore, a wellbore servicing method may comprise conveying the wellbore servicing fluid from its source to the wellbore via the operation of the pump 10 disclosed herein.

In alternative embodiments, the reciprocating apparatus may comprise a compressor. In embodiments, a compressor similar to the pump 10 may comprise at least one each of a cylinder, plunger, connecting rod, crankshaft, and housing, and may be coupled to a motor. In embodiments, such a compressor may be similar in form to a pump and may be configured to compress a compressible fluid (e.g., a gas) and thereby increase the pressure of the compressible fluid. For example, a compressor may be configured to direct the discharge therefrom to a chamber or vessel that collects the compressible fluid from the discharge of the compressor until a predetermined pressure is built up in the chamber. Generally, a pressure sensing device may be arranged and configured to monitor the pressure as it builds up in the chamber and to interact with the compressor when a predetermined pressure is reached. At that point, the compressor may either be shut off, or alternatively the discharge may be directed to another chamber for continued operation.

In embodiments, a reciprocating apparatus comprises an internal combustion engine, hereinafter referred to as an engine. Such engines are also well known, and typically include at least one each of a plunger, cylinder, connecting rod, and crankshaft. The arrangement of these components is substantially the same in an engine and a pump (e.g. pump 10). A reciprocating element 18 such as a plunger may be similarly arranged to move in reciprocating fashion within the cylinder. Skilled artisans will appreciate that operation of an engine may somewhat differ from that of a pump. In a pump, rotational power is generally applied to a crankshaft acting on the plunger via the connecting rod, whereas in an engine, rotational power generally results from a force (e.g., an internal combustion) exerted on or against the plunger, which acts against the crankshaft via the connecting rod.

For example, in a typical 4-stroke engine, arbitrarily beginning with the exhaust stroke, the plunger is fully extended during the exhaust stroke, (e.g., minimizing the internal volume of the cylinder). The plunger may then be retracted by inertia or other forces of the engine componentry during the intake stroke. As the plunger retracts within the cylinder, the internal volume of cylinder increases, creating a low pressure within the cylinder into which an air/fuel mixture is drawn. When the plunger is fully retracted within the cylinder, the intake stroke is complete, and the cylinder is substantially filled with the air/fuel mixture. As the crankshaft continues to rotate, the plunger may then be extended, during the compression stroke, into the cylinder compressing the air-fuel mixture within the cylinder to a higher pressure.

A spark plug may be provided to ignite the fuel at a predetermined point in the compression stroke. This ignition increases the temperature and pressure within the cylinder substantially and rapidly. In a diesel engine, however, the spark plug may be omitted, as the heat of compression derived from the high compression ratios associated with diesel engines suffices to provide spontaneous combustion of the air-fuel mixture. In either case, the heat and pressure act forcibly against the plunger and cause it to retract back into the cylinder during the power cycle at a substantial force, which may then be exerted on the connecting rod, and thereby on to the crankshaft.

Those of ordinary skill in the art will readily appreciate various benefits that may be realized by the present disclosure. The aligned valve (e.g., horizontall oriented aligned valve) provides a means to urge and align the sealing surface of the valve with the sealing surface of the valve seat without additional features that may cause the valve to tilt upon opening. Without the urging and aligning feature, the valve may not have adequate time to re-center causing the valve to load at an angle. This can cause the valve body to shear or fatigue and fail and dramatically reduce the life of the valve. The disclosed valve assembly can avoid the tendency to tilt at opening by coupling the spring member to the housing for uniform sealing and loading. With the guiding feature of the spring member, upon opening and closing, the central axis of the valve body can remain parallel to the flow path (e.g., the housing bore), allowing for uniform loading of the valve seal surface to the valve seat. Therefore, the present design increases valve life, lowers total component cost, provides decreased maintenance spend, and decreases non-productive (i.e., down) time on location.

### Additional Disclosure

The following enumerated aspects of the present disclosure are provided as non-limiting examples.

A first embodiment, which is a valve assembly comprising: a valve body generally cylinder in shape with an outer surface and a valve seat contact surface; a valve housing generally cylinder in shape with an outer surface, an inner surface, and a valve seat; a spring member coupled to the valve body and the valve housing, and wherein the spring member is configured to bias the valve body into contact with the housing; and wherein the spring member is located on a discharge side of the valve body.

A second embodiment, which is the valve assembly of the first embodiment wherein the spring member is configured to position a central axis of the valve body concentric with a central axis of the valve housing.

A third embodiment, which is the valve assembly of the first or the second embodiment wherein a first end and a second end of the spring member is coupled to the valve housing and wherein an attachment end on the spring member is coupled to an engagement feature on the valve housing.

A fourth embodiment, which is the valve assembly of the third embodiment wherein spring member is a flat spring, a coil spring, or a torsion spring.

A fifth embodiment, which is the valve assembly of any of the first through the fourth embodiments wherein the spring member is a progressive spring comprising a first spring member with a first spring rate and a second spring member with a second spring rate, and wherein the first spring rate is greater than the second spring rate.

A sixth embodiment, which is the valve assembly of any of the first through the fifth embodiments wherein the valve body comprises a travel limiter, wherein the travel limiter is a ring shaped protrusion on the discharge side of the valve body, and wherein the travel limiter is configured to contact the spring member.

A seventh embodiment, which is the valve assembly of the sixth embodiment wherein the valve seat comprises a valve seat surface, a hardened surface, an elastomeric seal, or combinations thereof.

An eighth embodiment, which is the valve assembly of the seventh embodiment wherein the valve seat contact surface is a curved shape configured to form a seal with a valve seat of the valve housing.

A ninth embodiment, which is the valve assembly of the seventh or the eighth embodiment wherein the valve seat contact surface comprises a valve seal configured to form a seal with the valve seat of the valve housing, and wherein the valve seal is an elastomeric seal.

A tenth embodiment, which is the valve assembly of any of the first through the ninth embodiments wherein the valve body comprises at least two wings with a sliding fit inside a bore of the valve housing, wherein the at least two wings are configured to align a contact surface of the valve body with a valve seat within the valve housing.

An eleventh embodiment, which is a pump fluid end comprising: a reciprocating element disposed at least partially within a reciprocating element bore of the pump fluid end; a discharge valve assembly; and a suction valve assembly, wherein the discharge valve assembly and/or the suction valve assembly is a valve assembly comprising a valve body, a valve housing, a spring member connecting the valve body to the valve housing, wherein the spring member is configured to bias the valve body into contact with a valve seat located on the valve housing, and wherein the spring member is located on a discharge side of the valve body.

A twelfth embodiment, which is the pump fluid end of the eleventh embodiment wherein the pump fluid end is a concentric bore pump fluid end, wherein the discharge valve assembly is positioned at least partially within the reciprocating element bore and is coaxially aligned with the suction valve assembly.

A thirteenth embodiment, which is the pump fluid end of the eleventh through the twelfth embodiment, wherein the suction valve assembly comprises the valve assembly and a valve seat, and wherein the reciprocating element is at least partially hollow and has a front end opposite a tail end along a central axis of the reciprocating element bore, and the suction valve assembly is coupled with the front end of the reciprocating element.

A fourteenth embodiment, which is the pump fluid end of the eleventh through the thirteenth embodiment wherein the spring member is configured to position a central axis of the valve body concentric with a central axis of the valve housing, and wherein a first end of the spring member couples to a first engagement feature on the valve housing and a second end of the spring member couples to a second engagement feature on the valve housing.

A fifteenth embodiment, which is the pump fluid end of the eleventh embodiment further comprising a second spring member coupled to the valve body with a first end of the second spring member coupled to a third engagement feature on the valve housing and a second end of the second spring member coupled to a fourth engagement feature on the valve housing, and wherein the second spring member is configured to position a central axis of the valve body concentric with a central axis of the valve housing.

A sixteenth embodiment, which is the pump fluid end of any of the eleventh through the fifteenth embodiments wherein the spring member is a progressive spring comprising a first spring member with a first spring rate and a second spring member with a second spring rate.

A seventeenth embodiment, which is the pump fluid end of any of the eleventh through the sixteenth embodiments wherein the valve body comprises a travel limiter configured to change the spring rate of the spring member in response to the travel limiter contacting the spring member.

An eighteenth embodiment, which is the pump fluid end of any of the eleventh through the seventeenth embodiments wherein the valve body comprises at least two wings protruding from the inlet side of the valve body configured with a sliding fit inside an inlet of the reciprocating element.

A nineteenth embodiment, which is a pump comprising the pump fluid end of claim 11.

A twentieth embodiment, which is a method of servicing a wellbore, the method comprising fluidly coupling a pump to a source of a wellbore servicing fluid and to the wellbore; and communicating wellbore servicing fluid into the wellbore via the pump, wherein the pump comprises a pump fluid end and a pump power end, wherein the pump fluid end comprises: a reciprocating element disposed at least partially within a reciprocating element bore of the pump fluid end; a discharge valve assembly; and a suction valve assembly, wherein the discharge valve assembly or the suction valve assembly comprises a valve seat and a valve assembly, wherein the valve assembly comprises: a valve housing, a valve body, and a spring member coupling the valve body to the valve housing, wherein the spring member is located on a discharge side of the valve body; and wherein the pump power end is operable to reciprocate the reciprocating element within the reciprocating element bore of the pump fluid end.

A twenty-first embodiment, which is the method of the twentieth embodiments wherein the valve assembly is housed within a fluid end of a positive displacement pump and the method further comprises operating the pump to place a wellbore servicing fluid in a wellbore.

A twenty-second embodiment wherein the wellbore servicing fluid comprises a fracturing fluid, a cementitious fluid, a remedial fluid, a perforating fluid, a sealant, a drilling fluid, a spacer fluid, a completion fluid, a gravel pack fluid, a diverter fluid, a gelation fluid, a polymeric fluid, an aqueous fluid, an oleaginous fluid, or a combination thereof.

A twenty-third embodiment, which is the valve assembly of the first or the second embodiment wherein a first end of the spring member is coupled to the valve housing and wherein an attachment end on the spring member is coupled to an engagement feature on the valve housing.

A twenty-fourth embodiment, which is the valve assembly of any of the first through the ninth embodiments wherein the valve body comprises a blade structure with at least two guiding surfaces with a sliding fit inside a bore of the valve housing, wherein the blade structure with at least two guiding surfaces are configured to align a contact surface of the valve body with a valve seat within the valve housing.

A twenty-fifth embodiment, which is the pump fluid end of the eleventh through the thirteenth embodiment wherein the spring member is configured to position a central axis of the valve body concentric with a central axis of the valve housing, and wherein a first end of the spring member couples to a first engagement feature on the valve housing.

A twenty-sixth embodiment, which is the pump fluid end of the eleventh embodiment further comprising a second spring member coupled to the valve body with a first end of the second spring member coupled to a second engagement feature on the valve housing, and wherein the second spring member is configured to position a central axis of the valve body concentric with a central axis of the valve housing.

A twenty-seventh embodiment, which is the pump fluid end of any of the eleventh through the seventeenth embodiments wherein the valve body comprises a blade structure protruding from the inlet side of the valve body with an upper guiding surface and a lower guiding surface configured with a sliding fit inside an inlet of the reciprocating element.

A twenty-eighth embodiment, which is the valve assembly of any of the first through the ninth embodiments wherein the valve body comprises a guide structure with at least two guiding surfaces with a sliding fit inside a bore of the valve housing, wherein the at least two guiding surfaces are configured to align a contact surface of the valve body with a valve seat within the valve housing.

A twenty-ninth embodiment, which is the valve assembly of the twenty-eighth embodiment wherein the guide structure comprises a blade structure with at least two guiding surfaces.

A thirtieth embodiment, which is the valve assembly of the twenty-eighth embodiment wherein the guide structure comprises a wing structure with at least two guiding surfaces.

A thirty-first embodiment, which is the pump fluid end of any of the eleventh through the seventeenth embodiments wherein the valve body comprises a guide structure protruding from the inlet side of the valve body with a first guiding surface and a second guiding surface configured with a sliding fit inside an inlet of the reciprocating element.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment. i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference herein is not an admission that it is prior art, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed:

1. A valve assembly comprising:
a valve body generally cylinder in shape with an outer surface and a valve seat contact surface;
a valve housing generally cylinder in shape with an outer surface, an inner surface, and a valve seat;
a spring member coupled to the valve body and the valve housing, and wherein the spring member is configured to bias the valve body into contact with the housing; and
wherein the spring member is located on a discharge side of the valve body.

2. The valve assembly of claim 1, wherein the spring member is configured to position a central axis of the valve body concentric with a central axis of the valve housing.

3. The valve assembly of claim 1, wherein a first end of the spring member is coupled to the valve housing and wherein an attachment end on the spring member is coupled to an engagement feature on the valve housing.

4. The valve assembly claim 1, wherein spring member is a flat spring, a coil spring, or a torsion spring.

5. The valve assembly of claim 1, wherein the spring member is a progressive spring comprising a first spring member with a first spring rate and a second spring member with a second spring rate, and wherein the first spring rate is greater than the second spring rate.

6. The valve assembly of claim 1, wherein the valve body comprises a travel limiter, wherein the travel limiter is a ring shaped protrusion on the discharge side of the valve body, and wherein the travel limiter is configured to contact the spring member.

7. The valve assembly of claim 1, wherein the valve seat comprises a valve seat surface, a hardened surface, an elastomeric seal, or combinations thereof.

8. The valve assembly of claim 1, wherein the valve seat contact surface is a curved shape configured to form a seal with a valve seat of the valve housing.

9. The valve assembly of claim 1, wherein the valve seat contact surface comprises a valve seal configured to form a seal with the valve seat of the valve housing, and wherein the valve seal is an elastomeric seal.

10. The valve assembly of claim 1, wherein the valve body comprises a guide structure with at least two guiding surfaces with a sliding fit inside a bore of the valve housing, wherein the guide structure with at least two guiding surfaces is configured to align a contact surface of the valve body with a valve seat within the valve housing.

11. The valve assembly of claim 10, wherein the guide structure comprises a blade structure with at least two guiding surfaces.

12. The valve assembly of claim 10, wherein the guide structure comprises a wing structure with at least two guiding surfaces.

13. A pump fluid end comprising:
a reciprocating element disposed at least partially within a reciprocating element bore of the pump fluid end;
a discharge valve assembly; and
a suction valve assembly,
wherein the discharge valve assembly and/or the suction valve assembly is a valve assembly comprising a valve body, a valve housing, a spring member connecting the valve body to the valve housing, wherein the spring member is configured to bias the valve body into contact with a valve seat located on the valve housing, and wherein the spring member is located on a discharge side of the valve body.

14. The pump fluid end of claim 13, wherein the pump fluid end is a concentric bore pump fluid end, wherein the discharge valve assembly is positioned at least partially within the reciprocating element bore and is coaxially aligned with the suction valve assembly.

15. The pump fluid end of claim 13, wherein the suction valve assembly comprises the valve assembly and a valve seat, and wherein the reciprocating element is at least partially hollow and has a front end opposite a tail end along a central axis of the reciprocating element bore, and the suction valve assembly is coupled with the front end of the reciprocating element.

16. The pump fluid end of claim 13, wherein the spring member is configured to position a central axis of the valve body concentric with a central axis of the valve housing, and wherein a first end of the spring member couples to a first engagement feature on the valve housing.

17. The pump fluid end of claim 13, further comprising a second spring member coupled to the valve body with a first end of the second spring member coupled to a second engagement feature on the valve housing, and wherein the second spring member is configured to position a central axis of the valve body concentric with a central axis of the valve housing.

18. The pump fluid end of claim 13, wherein the spring member is a progressive spring comprising a first spring member with a first spring rate and a second spring member with a second spring rate.

19. The pump fluid end of claim 13, wherein the valve body comprises a travel limiter configured to change the spring rate of the spring member in response to the travel limiter contacting the spring member.

20. The pump fluid end of claim 13, wherein the valve body comprises a guide structure protruding from the inlet side of the valve body with a first guiding surface and a second guiding surface configured with a sliding fit inside an inlet of the reciprocating element.

21. A pump comprising the pump fluid end of claim 13.

22. A method of servicing a wellbore, the method comprising:
fluidly coupling a pump to a source of a wellbore servicing fluid and to the wellbore;
and communicating wellbore servicing fluid into the wellbore via the pump,
wherein the pump comprises a pump fluid end and a pump power end, wherein the pump fluid end comprises:
a reciprocating element disposed at least partially within a reciprocating element bore of the pump fluid end;
a discharge valve assembly:
and a suction valve assembly, wherein the discharge valve assembly or the suction valve assembly comprises a valve seat and a valve assembly, wherein the valve assembly comprises:
a valve housing, a valve body, and a spring member coupling the valve body to the valve housing, wherein the spring member is located on a discharge side of the valve body;
and wherein the pump power end is operable to reciprocate the reciprocating element within the reciprocating element bore of the pump fluid end.

23. The method of claim 22, wherein the valve assembly is housed within a fluid end of a positive displacement pump and the method further comprises operating the pump to place a wellbore servicing fluid in a wellbore.

24. The method of claim 22, wherein the wellbore servicing fluid comprises a fracturing fluid, a cementitious fluid, a remedial fluid, a perforating fluid, a sealant, a drilling fluid, a spacer fluid, a completion fluid, a gravel pack fluid, a diverter fluid, a gelation fluid, a polymeric fluid, an aqueous fluid, an oleaginous fluid, or a combination thereof.
